(19) United States
(12) Patent Application Publication
(10) Pub. No.: US 2023/0257553 A1
(43) Pub. Date: Aug. 17, 2023

(54) SYNTHESIS OF SILANE COMPOUNDS

(71) Applicant: MOMENTIVE PERFORMANCE MATERIALS INC., Niskayuna, NY (US)

(72) Inventors: Matthew J. PINNOW, Millwood, NY (US); Yogesh CHANDRASEKARAN, Bangalore (IN); Lesley HWANG, Chappaqua, NY (US); Christopher M. PAPPAS, Charlotte, NC (US); Nidhi SHARMA, Bangalore (IN)

(21) Appl. No.: 18/169,523

(22) Filed: Feb. 15, 2023

Related U.S. Application Data
(60) Provisional application No. 63/268,041, filed on Feb. 15, 2022.

(51) Int. Cl. C08K 5/544; C08L 9/06; C08C 19/22; C08C 19/25; C08K 5/548; C08K 5/541; C08F 2/06

(52) U.S. Cl. CPC C08K 5/544; C08L 9/06; C08C 19/22; C08C 19/25; C08K 5/548; C08K 5/541; C08F 2/06

(57) ABSTRACT

The present disclosures are directed to a silane coupling agent, two silane functional polymers, a method of making a silane coupling agent, the use of a silane coupling agent for making a silane functional polymer, a method of making a silane functional polymer by removing a protecting group, and a composition comprising one or more silane functional polymers.

### CROSS REFERENCE TO RELATED APPLICATIONS

This application claims priority to U.S. Provisional Patent Application No. 63/268,041, filed Feb. 15, 2022, which is incorporated herein by reference in its entirety.

### FIELD OF THE DISCLOSURE

The present disclosure relates to silane coupling agents, silane functional polymers, a method of making silane coupling agents, and the use of silane coupling agents for making silane functional polymers. The present disclosure further relates to a composition comprising one or more silane functional polymers, as well as a number of usage compositions.

### BACKGROUND

The addition of silane functionality to solution styrene butadiene rubber (SSBR) polymers is desired by polymer manufacturers and tire compounders as it produces rubber compounds with improved properties (wear, rolling resistance, handling, etc.). Traditionally, the addition of aminosilanes/thiosilane/oxysilane to SSBR polymers is problematic as the N—H/S—H/O—H functionality will poison the living polymer and will result in no silane functionality being added to SSBR polymers.

To overcome this technical deficiency of standard silane compounds, it is known to use either tertiary aminosilanes (US2021/0130591 A1), which have no N—H functionality, or protected aminosilanes (JP 11349632). The tertiary silane compounds are not preferred, due to the lack of N—H/S—H/O—H functionality. The presence of N—H/S—H/O—H functionality enables hydrogen bonding to the silica in rubber compounds, which improves polymer/silica interaction leading to improve rubber properties.

The use of a protecting group on a silane compound has also shown technical challenges associated with the stability of the protecting group (U.S. Ser. No. 10/457,697B2). Therefore, there is a need for improved methods to prepare silane compounds.

### BRIEF SUMMARY OF THE DISCLOSURE

A silane compound disclosed herein has formula (I)

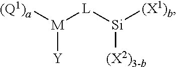

wherein:

M is selected from the group consisting of nitrogen, sulfur and oxygen;

Y is a protecting group;

Q¹ is -L-Si—(X¹)_{d}(X²)_{3-d} or R¹;

each L is independently absent, an optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, or an optionally substituted aralkylene group having from 7 to 16 carbon atoms and optionally at least one heteroatom;

each X¹ is independently —OR¹ or —OC(═O)R¹;

each X² is R¹;

each R¹ is independently selected from the group consisting of an optionally substituted alkyl group having from 1 to 20 carbon atoms and optionally at least one heteroatom, an optionally substituted alkenyl group having from 2 to 20 carbon atoms and optionally at least one heteroatom, an optionally substituted alkynyl group having from 2 to 20 carbon atoms and optionally at least one heteroatom, an optionally substituted cycloalkyl group having from 3 to 10 carbon atoms and optionally at least one heteroatom, an optionally substituted aryl group having from 6 to 12 carbon atoms and optionally at least one heteroatom, an optionally substituted aralkyl group having from 7 to 16 carbon atoms and optionally at least one heteroatom, and an optionally substituted cyclic silane; or is a divalent group formed from two R¹ groups being bonded together through a covalent bond, with the proviso that if two R¹ groups are bonded together then b is 2 or 3;

a is 0 or 1; with the proviso that if M is nitrogen, a is 1; if M is sulfur or oxygen, a is 0;

b is 1, 2, or 3; and

d is 0, 1, 2, or 3.

The disclosure further relates to a polymer having formula (II)

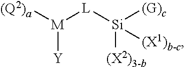

wherein:

M, Y, each L, each X¹, each X², each R¹, a, b, and d are described as in formula (I).

Q² is -L-Si-(G)ₑ(X¹)_{d-e}(X²)_{3-d} or R¹;

G is a polymer fragment having a backbone of carbon atoms covalently bonded together by C—C single bond, C—C double bond or a combination of C—C single bonds and C—C double bonds;

c is 1, 2, or 3, with the proviso that c is equal to or less than b; and

e is 0, 1, 2, or 3, with the proviso that e is equal to or less than d.

The disclosure also relates to a polymer having formula (III)

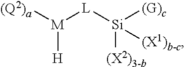

wherein:

M, each L, each X¹, each X², each R¹, Q², G, a, b, c, d and e are described as in formula (II).

The disclosure further provides a polymer fragment G having formula (IV)

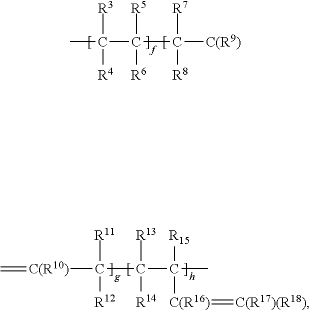

wherein:

each R³, R⁴, R⁵, R⁷, R⁸, R⁹, R¹⁰, R¹¹, R¹², R¹³, R¹⁴, R¹⁵, R¹⁶, R¹⁷ and R¹⁸ is independently an alkyl group having from 1 to 20 carbon atoms, or hydrogen;

each R⁶ is independently selected from the group consisting of hydrogen, an alkyl group having from 1 to 20 carbon atoms and optionally at least one heteroatom, an alkenyl group having from 2 to 20 carbon atoms, a cycloalkyl group having from 3 to 14 carbon atoms, a cycloalkenyl group having from 4 to 14 carbon atoms, an aryl group having from 6 to 16 carbon atoms, and an aralkyl group having from 7 to 20 carbon atoms; and

f, g and h are integers, wherein f is equal to or greater than 0, g is equal to or greater than 0, and h is equal to or greater than 0, with the proviso that the sum of f, g and h is equal to or greater than 1.

The disclosure also provides a method of making a silane compound of formula (I)

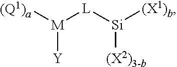

comprising reacting a compound of formula (V)

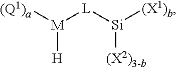

with a protective agent; wherein M, Y, Q¹, each L, each X¹, each X², each R¹, a, b, and d are described as in formula (I).

The disclosure also provides a method of making a polymer of formula (II)

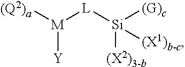

comprising reacting a chain of CC unsaturated carbon atom monomers with an anionic initiator to form a polymer fragment G; and reacting the polymer fragment G with a silane compound of formula (I) with the proviso that if Q¹ is -L-Si—(X¹)_{d}(X²)_{3-d}, Q² is -L-Si-(G)ₑ(X¹)_{d-e}(X²)_{3-d}; and if Q¹ is R¹, Q² is R¹;

The disclosure further provides a method of making a polymer of formula (III)

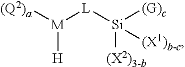

comprising reacting a polymer of formula (II)

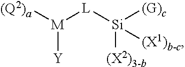

under suitable conditions, wherein:

M, Y, each L, each X¹, each X², each R¹, Q², G, a, b, c, d and e are described as in formula (II).

### DETAILED DESCRIPTION

As used above, and throughout the description, the following terms, unless otherwise indicated, shall be understood to have the following meanings.

Unless stated otherwise, the terms “a” and “an” and “the” and similar references used in the context of describing a particular aspect of the application (especially in the context of claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein.

Furthermore, “and/or”, where used herein, is to be taken as specific disclosure of each of the two specified features or components with or without the other. Thus, the term “and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following aspects: A, B, and C; A, B, or C; A or C; A or B; B or C; A and C; A and B; B and C; A (alone); B (alone); and C (alone).

It is understood that wherever aspects are described herein with the language “comprising,” otherwise analogous aspects described in terms of “consisting of” and/or “consisting essentially of” are also provided.

The term “polymer” means a substance, chemical compound or mixture of compounds, that has a molecular structure consisting chiefly or entirely of a large number of similar units (e.g., monomer units) bonded together.

The term “about” encompasses the range of experimental error that occurs in any measurement.

The expression “coupling agent” means an agent capable of establishing an effective chemical and/or physical bond between a diene based polymer and a filler or means an agent capable of establishing an effective chemical or physical bond between two diene based polymers. Effective coupling agents have functional groups capable of bonding physically and/or chemically with filler or a second diene based polymer, as for example, between a silanol group of the coupling agent and the hydroxyl (OH) surface groups of the filler (e.g., surface silanols in the case of silica), or between a silanol group attached to one diene polymer with the silanol group of another polymer, and, as for example, sulfur atoms which are capable of bonding physically and/or chemically with the diene based polymers as a result of vulcanization (curing).

The term, “hydrocarbon” as used herein refers to any chemical structure containing hydrogen atoms and carbon atoms.

The term “alkyl” means any monovalent, saturated straight chain or branched chain hydrocarbon group; the term “alkenyl” means any monovalent straight chain or branched chain hydrocarbon group containing one or more carbon-carbon double bonds where the site of attachment of the group can be either at a carbon-carbon double bond or elsewhere therein; and, the term “alkynyl” means any monovalent straight chain or branched chain hydrocarbon group containing one or more carbon-carbon triple bonds and, optionally, one or more carbon-carbon double bonds, where the site of attachment of the group can be either at a carbon-carbon triple bond, a carbon-carbon double bond or elsewhere therein.

Representative examples of alkyls include methyl, ethyl, propyl and isobutyl. Examples of alkenyls include vinyl, propenyl, allyl, methallyl, ethylidenyl norbornane, ethylidene norbornyl, ethylidenyl norbornene and ethylidene norbornenyl. Examples of alkynyls include acetylenyl, propargyl and methylacetylenyl.

The term “cycloalkyl” means any monovalent cyclic aliphatic hydrocarbon group; the term “cycloalkenyl” means any monovalent cyclic aliphatic hydrocarbon group containing one or more carbon-carbon double bonds where the site of attachment of the group can be either at a carbon-carbon double bond or elsewhere therein; and, the term “cycloalkynyl” means any monovalent cyclic aliphatic hydrocarbon group containing one or more carbon-carbon triple bonds and, optionally, one or more carbon-carbon double bonds, where the site of attachment of the group can be either at a carbon-carbon triple bond, a carbon-carbon double bond or elsewhere therein.

Representative examples of cycloalkyl include cyclopentyl, cyclobutyl, cyclopentyl, cycloheptyl, cyclooctyl. Examples of cyloalkenyl include cyclopentenyl, cycloheptenyl and cyclooctatrienyl. An example of cycloalkynyl is cycloheptynyl.

The terms “cycloalkyl”, “cycloalkenyl”, and “cycloalkynyl” include bicyclic, tricyclic and higher cyclic structures as well as the aforementioned cyclic structures further substituted with alkyl, alkenyl, and/or alkynyl groups. Representative examples include norbornyl, norbornenyl, ethylnorbornyl, ethylnorbornenyl, cyclohexyl, ethylcyclohexyl, ethylcyclohexenyl, cyclohexylcyclohexyl and cyclododecatrienyl.

The term “aryl” includes any aromatic hydrocarbon from which one hydrogen atom has been removed; “aralkyl” includes any of the aforementioned alkyl groups in which one or more hydrogen atoms have been substituted by the same number of like and/or different aryl (as defined herein) substituents; and “arenyl” includes any of the aforementioned aryl groups in which one or more hydrogen atoms have been substituted by the same number of like and/or different alkyl (as defined herein) substituents. Specific, non-limiting examples of aryl groups include phenyl and naphthalenyl. Specific, non-limiting examples of aralkyl groups include benzyl and phenethyl. Specific, non-limiting examples of arenyl groups include tolyl and xylyl.

The term “alkylene” is a divalent saturated aliphatic radical derived from an alkane by removal of two hydrogen atoms.

The term “heteroatom” means any of the Group 13-17 elements except carbon and includes, for example, oxygen, nitrogen, silicon, sulfur, phosphorus, fluorine, chlorine, bromine and iodine.

The term “halo” or “halogen” as used by itself or as part of another group refers to —CI, —F, —Br, or —I.

Other than in the working examples or where otherwise indicated, all numbers expressing amounts of materials, reaction conditions, time durations, quantified properties of materials, and so forth, stated in the specification and claims are to be understood as being modified in all instances by the term “about”.

It will be understood that any numerical range recited herein includes all sub-ranges with that range and any combination of the various endpoints of such ranges or sub-ranges.

It will be further understood that any compound, material or substance which is expressly or implicitly disclosed in the specification and/or recited in a claim as belonging to a group of structurally, compositionally and/or functionally related compounds, materials or substances includes individual representatives of the group and all combinations thereof.

A silane compound disclosed herein has formula (I)

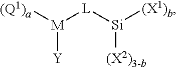

wherein:

M is selected from the group consisting of nitrogen, sulfur and oxygen;

Y is a protecting group;

Q¹ is -L-Si—(X¹)_{d}(X²)_{3-d} or R¹;

each L is independently absent, an optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, or an optionally substituted aralkylene group having from 7 to 16 carbon atoms and optionally at least one heteroatom;

each X¹ is independently —OR¹ or —OC(═O)R¹;

each X² is R¹;

each R¹ is independently selected from the group consisting of an optionally substituted alkyl group having from 1 to 20 carbon atoms and optionally at least one heteroatom, an optionally substituted alkenyl group having from 2 to 20 carbon atoms and optionally at least one heteroatom, an optionally substituted alkynyl group having from 2 to 20 carbon atoms and optionally at least one heteroatom, an optionally substituted cycloalkyl group having from 3 to 10 carbon atoms and optionally at least one heteroatom, an optionally substituted aryl group having from 6 to 12 carbon atoms and optionally at least one heteroatom, an optionally substituted aralkyl group having from 7 to 16 carbon atoms and optionally at least one heteroatom, and an optionally substituted cyclic silane; or is a divalent group formed from two R¹ groups being bonded together through a covalent bond, with the proviso that if two R¹ groups are bonded together then b is 2 or 3;

a is 0 or 1; with the proviso that if M is nitrogen, a is 1; if M is sulfur or oxygen, a is 0;

b is 1, 2, or 3; and

d is 0, 1, 2, or 3.

In some aspects, Y is selected from the group consisting of

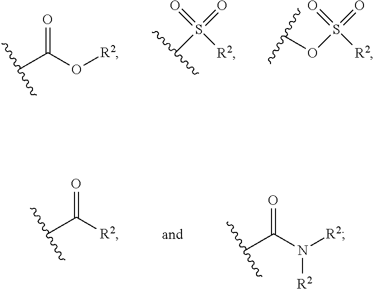

and further wherein:

each R² is independently selected from the group consisting of an optionally substituted alkyl group having from 1 to 20 carbon atoms and optionally at least one heteroatom, an optionally substituted alkenyl group having from 2 to 20 carbon atoms and optionally at least one heteroatom, an optionally substituted cycloalkyl group having from 3 to 14 carbon atoms and optionally at least one heteroatom, an optionally substituted aryl group having from 6 to 16 carbon atoms and optionally at least one heteroatom, and an optionally substituted aralkyl group having from 7 to 20 carbon atoms and optionally at least one heteroatom.

In some aspects, Y is selected from the group consisting of

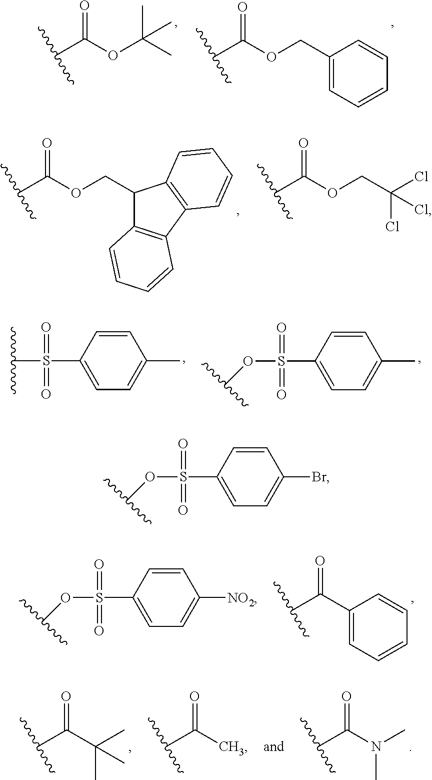

In some aspects, Y is

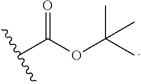 [SMILES: *C(=O)OC(C)(C)C]

In some aspects, M is nitrogen, a is 1, and the silane compound of formula (I) is

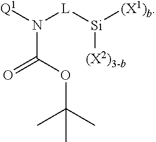

In some aspects, Q¹ is -L-Si—(X¹)_{d}(X²)_{3-d}, and the silane compound of formula (I) is

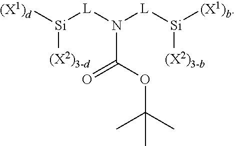

In some aspects, each L is an optionally substituted alkylene group having from 1 to 20 carbon atoms.

In some aspects, each L is —CH₂CH₂CH₂—.

In some aspects, each X¹ is —OR¹.

In some aspects, each R¹ is an optionally substituted alkyl group having from 1 to 20 carbon atoms.

In some aspects, each R¹ is an ethyl group.

In some aspects, b is 3.

In some aspects, d is 3.

In some aspects, the silane compound of formula (I) is

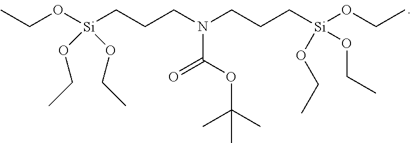 [SMILES: CCO[Si](CCCN(CCC[Si](OCC)(OCC)OCC)C(=O)OC(C)(C)C)(OCC)OCC]

In some aspects, Q¹ is R¹, and the silane compound of formula (I) is

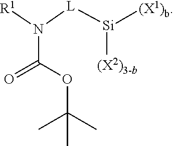

In some aspects, L is an optionally substituted alkylene group having from 1 to 20 carbon atoms. In some aspects, L is —CH₂CH₂CH₂—.

In some aspects, each X¹ is —OR¹.

In some aspects, each R¹ is independently an optionally substituted alkyl group having from 1 to 20 carbon atoms, or an optionally substituted aryl group having from 6 to 12 carbon atoms. In some aspects, R¹ is an ethyl group. In some aspects, R¹ is a methyl group. In some aspects, R¹ is a phenyl group.

In some aspects, b is 3.

In some aspects, the silane compound of formula (I) is

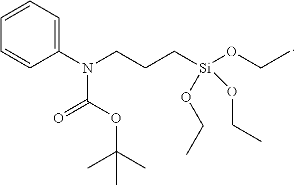 [SMILES: CCO[Si](CCCN(C(=O)OC(C)(C)C)c1ccccc1)(OCC)OCC]

In some aspects, the silane compound of formula (I) is

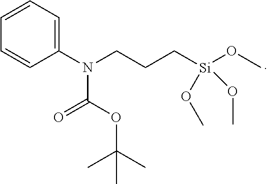 [SMILES: CO[Si](CCCN(C(=O)OC(C)(C)C)c1ccccc1)(OC)OC]

In some aspects, M is sulfur, a is 0, and the silane compound of formula (I) is

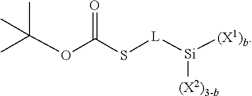

In some aspects, L is an optionally substituted alkylene group having from 1 to 20 carbon atoms. In some aspects, L is —CH₂CH₂CH₂—.

In some aspects, each X¹ is —OR¹.

In some aspects, each R¹ is an optionally substituted alkyl group having from 1 to 20 carbon atoms. In some aspects, each R¹ is an ethyl group.

In some aspects, b is 3.

In some aspects, the silane compound of formula (I) is

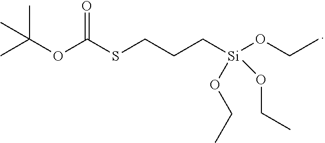 [SMILES: CCO[Si](CCCSC(=O)OC(C)(C)C)(OCC)OCC]

In some aspects, Y is

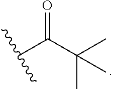 [SMILES: *C(=O)C(C)(C)C]

In some aspects, M is oxygen, a is 0, and the silane compound of formula (I) is

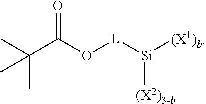

In some aspects, L is an optionally substituted alkylene group having from 1 to 20 carbon atoms. In some aspects, L is —CH₂CH₂CH₂—.

In some aspects, each X¹ is —OR¹.

In some aspects, each R¹ is an optionally substituted alkyl group having from 1 to 20 carbon atoms. In some aspects, each R¹ is an ethyl group.

In some aspects, b is 3.

In some aspects, the silane compound of formula (I) is

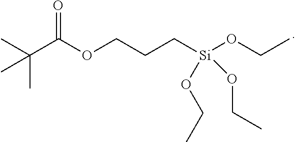 [SMILES: CCO[Si](CCCOC(=O)C(C)(C)C)(OCC)OCC]

The disclosure further relates to a polymer having formula (II)

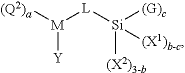

wherein:

M, Y, each L, each X¹, each X², each R¹, a, b, and d are described as in formula (I).

Q² is -L-Si-(G)ₑ(X¹)_{d-e}(X²)_{3-d} or R¹;

G is a polymer fragment having a backbone of carbon atoms covalently bonded together by C—C single bond, C—C double bond or a combination of C—C single bonds and C—C double bonds;

c is 1, 2, or 3, with the proviso that c is equal to or less than b; and

e is 0, 1, 2, or 3, with the proviso that e is equal to or less than d.

In some aspects, Y is selected from the group consisting of

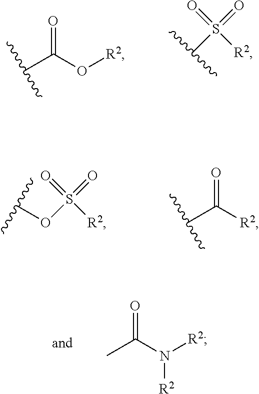

and further wherein each R² is described above.

In some aspects, Y is selected from the group consisting of

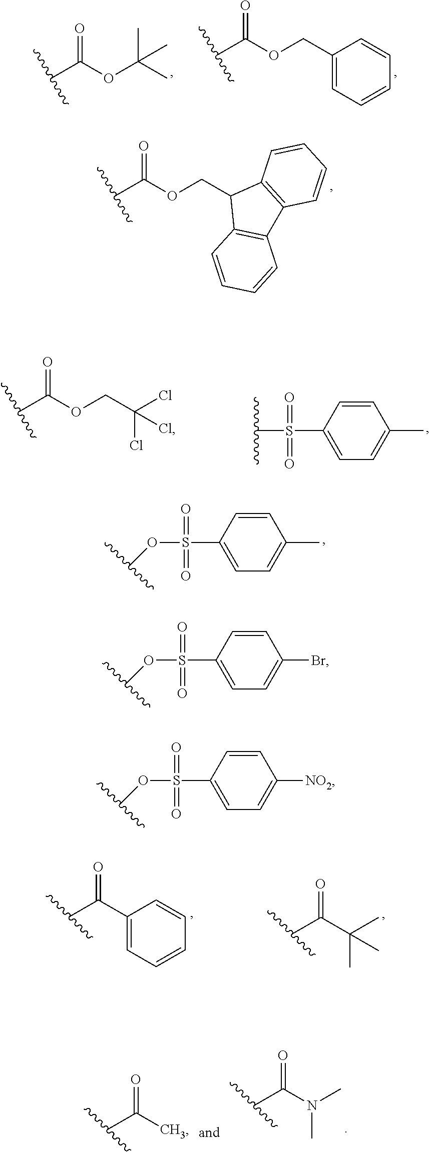

In some aspects, Y is

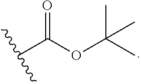 [SMILES: *C(=O)OC(C)(C)C]

In some aspects, M is nitrogen, a is 1, and the polymer of formula (II) is

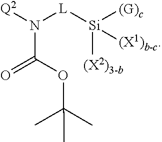

In some aspects, Q² is -L-Si-(G)ₑ(X)_{d-e}(X²)_{3-d}, and the polymer of formula (II) is

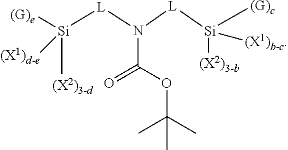

In some aspects, each L is an optionally substituted alkylene group having from 1 to 20 carbon atoms. In some aspects, each L is —CH₂CH₂CH₂—.

In some aspects, each X¹ is —OR¹.

In some aspects, each R¹ is an optionally substituted alkyl group having from 1 to 20 carbon atoms. In some aspects, each R¹ is an ethyl group.

In some aspects, c is 1.

In some aspects, b is 3.

In some aspects, e is 1.

In some aspects, d is 3.

In some aspects, the polymer of formula (II) is

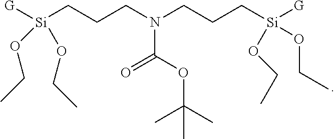

In some aspects, Q² is R¹, and the polymer of formula (II) is

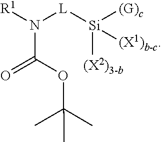

In some aspects, L is an optionally substituted alkylene group having from 1 to 20 carbon atoms. In some aspects, L is —CH₂CH₂CH₂—.

In some aspects, each X¹ is —OR¹.

In some aspects, each R¹ is independently an optionally substituted alkyl group having from 1 to 20 carbon atoms, or an optionally substituted aryl group having from 6 to 12 carbon atoms. In some aspects, R¹ is an ethyl group. In some aspects, R¹ is a methyl group. In some aspects, R¹ is a phenyl group.

In some aspects, c is 1.

In some aspects, b is 3.

In some aspects, the polymer of formula (II) is

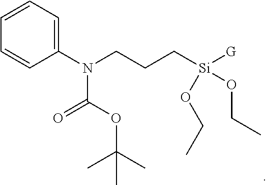

In some aspects, the polymer of formula (II) is

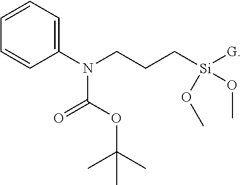

In some aspects, M is sulfur, a is 0, and the polymer of formula (II) is

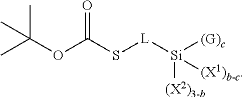

In some aspects, L is an optionally substituted alkylene group having from 1 to 20 carbon atoms. In some aspects, L is —CH₂CH₂CH₂—.

In some aspects, each X¹ is —OR¹.

In some aspects, each R¹ is an optionally substituted alkyl group having from 1 to 20 carbon atoms. In some aspects, each R¹ is an ethyl group.

In some aspects, c is 1.

In some aspects, b is 3.

In some aspects, the polymer of formula (II) is

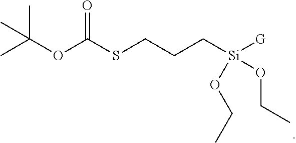

In some aspects, Y is

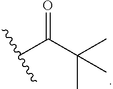 [SMILES: *C(=O)C(C)(C)C]

In some aspects, M is oxygen, a is 0, and the polymer of formula (II) is

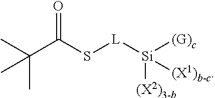

In some aspects, L is an optionally substituted alkylene group having from 1 to 20 carbon atoms. In some aspects, L is —CH₂CH₂CH₂—.

In some aspects, each X¹ is —OR¹.

In some aspects, each R¹ is an optionally substituted alkyl group having from 1 to 20 carbon atoms. In some aspects, each R¹ is an ethyl group.

In some aspects, c is 1.

In some aspects, b is 3.

In some aspects, the polymer of formula (II) is

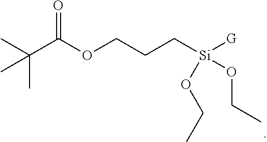

The disclosure also relates to a polymer having formula (III)

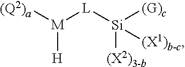

wherein:

M, each L, each X¹, each X², each R¹, a, b, and d are described as in formula (I).

Q² is -L-Si-(G)ₑ(X¹)_{d-e}(X²)_{3-d} or R¹;

G is a polymer fragment having a backbone of carbon atoms covalently bonded together by C—C single bond, C—C double bond or a combination of C—C single bonds and C—C double bonds;

c is 1, 2, or 3, with the proviso that c is equal to or less than b; and

e is 0, 1, 2, or 3, with the proviso that e is equal to or less than d.

In some aspects, M is nitrogen, a is 1, and the polymer of formula (III) is

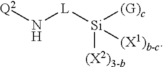

In some aspects, Q² is -L-Si-(G)ₑ(X¹)_{d-e}(X²)_{3-d}, and the polymer of formula (III) is

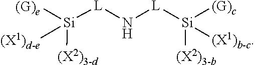

In some aspects, each L is an optionally substituted alkylene group having from 1 to 20 carbon atoms. In some aspects, each L is —CH₂CH₂CH₂—.

In some aspects, each X¹ is —OR¹.

In some aspects, each R¹ is an optionally substituted alkyl group having from 1 to 20 carbon atoms. In some aspects, each R¹ is an ethyl group.

In some aspects, c is 1.

In some aspects, b is 3.

In some aspects, e is 1.

In some aspects, d is 3.

In some aspects, the polymer of formula (III) is

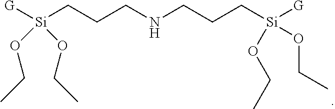

In some aspects, Q² is R¹, and the polymer of formula (III) is

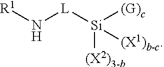

In some aspects, L is an optionally substituted alkylene group having from 1 to 20 carbon atoms. In some aspects, L is —CH₂CH₂CH₂—.

In some aspects, each X¹ is —OR¹.

In some aspects, each R¹ is independently an optionally substituted alkyl group having from 1 to 20 carbon atoms, or an optionally substituted aryl group having from 6 to 12 carbon atoms. In some aspects, R¹ is an ethyl group. In some aspects, R¹ is a methyl group. In some aspects, R¹ is a phenyl group.

In some aspects, c is 1.

In some aspects, b is 3.

In some aspects, the polymer of formula (III) is or

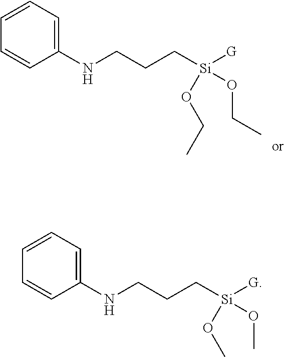

In some aspects, M is sulfur, a is 0, and the polymer of formula (III) is

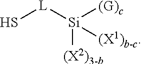

In some aspects, L is an optionally substituted alkylene group having from 1 to 20 carbon atoms. In some aspects, L is —CH₂CH₂CH₂—.

In some aspects, each X¹ is —OR¹.

In some aspects, each R¹ is an optionally substituted alkyl group having from 1 to 20 carbon atoms. In some aspects, each R¹ is an ethyl group.

In some aspects, c is 1.

In some aspects, b is 3.

In some aspects, the polymer of formula (III) is

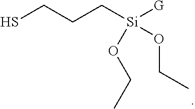

In some aspects, M is oxygen, a is 0, and the polymer of formula (III) is

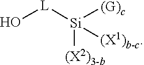

In some aspects, L is an optionally substituted alkylene group having from 1 to 20 carbon atoms. In some aspects, L is —CH₂CH₂CH₂—.

In some aspects, each X¹ is —OR¹.

In some aspects, each R¹ is an optionally substituted alkyl group having from 1 to 20 carbon atoms. In some aspects, each R¹ is an ethyl group.

In some aspects, c is 1.

In some aspects, b is 3.

In some aspects, the polymer of formula (III) is

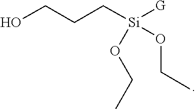

In some aspects, G is a polymer fragment of formula (IV)

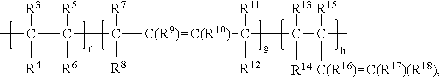

wherein:

each R³, R⁴, R⁵, R⁷, R⁸, R⁹, R¹⁰, R¹¹, R¹², R¹³, R¹⁴, R¹⁵, R¹⁶, R¹⁷ and R¹⁸ is independently an alkyl group having from 1 to 20 carbon atoms, or hydrogen;

each R⁶ is independently selected from the group consisting of hydrogen, an alkyl group having from 1 to 20 carbon atoms and optionally at least one heteroatom, an alkenyl group having from 2 to 20 carbon atoms, a cycloalkyl group having from 3 to 14 carbon atoms, a cycloalkenyl group having from 4 to 14 carbon atoms, an aryl group having from 6 to 16 carbon atoms, and an aralkyl group having from 7 to 20 carbon atoms; and

f, g and h are integers, wherein f is equal to or greater than 0, g is equal to or greater than 0, and h is equal to or greater than 0, with the proviso that the sum of f, g and h is equal to or greater than 1.

In some aspects, f is from 0 to 10,000. In some aspects, f is from 1 to 5,000. In some aspects, f is from 100 to 2,500.

In some aspects, g is from 0 to 10,000. In some aspects, g is from 0 to 5,000. In some aspects, g is from 100 to 2,500.

In some aspects, h is from 0 to 10,000. In some aspects, h is from 0 to 5,000. In some aspects, h is from 100 to 2,500.

In some aspects, the sum of f, g and h is from 100 to 5,000.

In some aspects, each R³, R⁴, R⁵, R⁷, R¹, R⁹, R¹⁰, R¹¹, R¹, R¹³, R¹⁴, R¹, R¹⁶, R¹⁷ and R⁸ is hydrogen.

In some aspects, each R⁶ is an aryl group having from 6 to 16 carbon atoms. In some aspects, each R⁶ is a phenyl group.

In some aspects, the polymer fragment G is styrene butadiene polymer.

The disclosure provides a method of making a silane compound of formula (I)

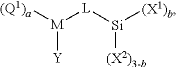

comprising reacting a compound of formula (V)

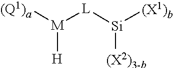

with a protective agent; wherein M, Y, Q¹, each L, each X¹, each X², each R¹, a, b, and d are described as in formula (I).

In some aspects, the protective agent is selected from the group consisting of

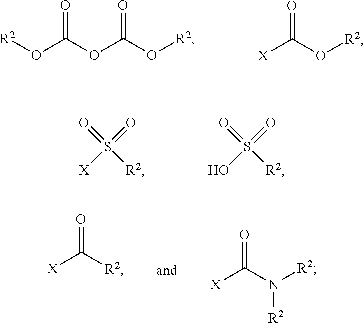

and further wherein X is halogen or OR²; and each R² is described above.

In some aspects, the protective agent is selected from the group consisting of

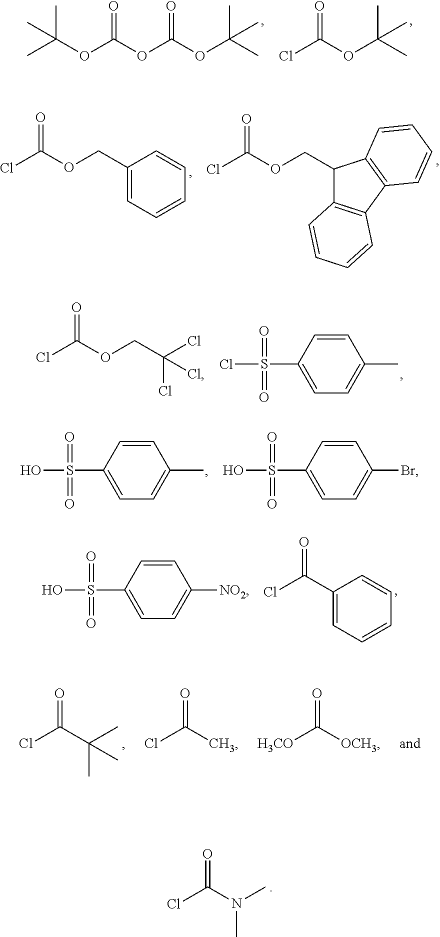

In some aspects, the protective agent is

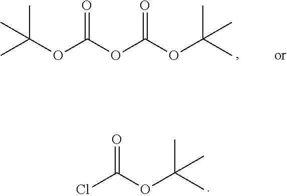

In some aspects, Y is selected from the group consisting of

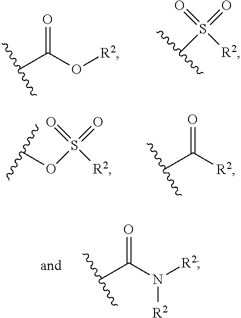

and further wherein each R² is described above.

In some aspects, Y is selected from the group consisting of

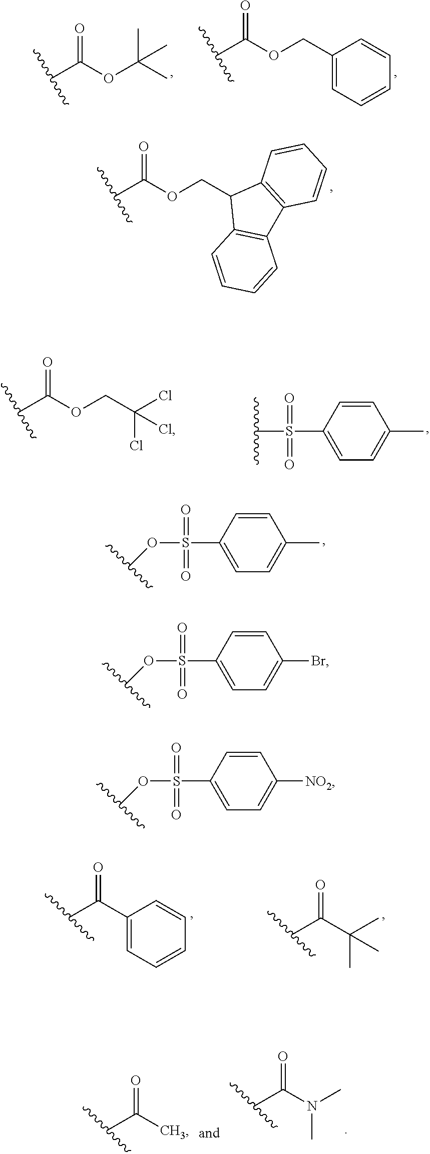

In some aspects, Y is

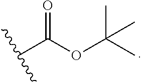 [SMILES: *C(=O)OC(C)(C)C]

In some aspects, M is nitrogen, a is 1, and the silane compound of formula (I)

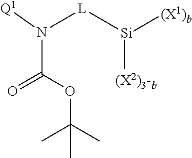

is prepared by reacting the compound of formula (V)

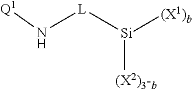

with the protective agent

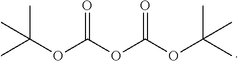

In some aspects, Q¹ is -L-Si—(X¹)_{d}(X²)_{3-d}, and the silane compound of formula (I)

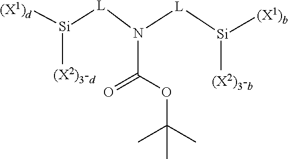

is prepared by reacting the compound of formula

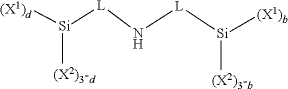

with the protective agent

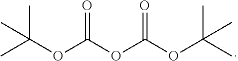

In some aspects, each L is an optionally substituted alkylene group having from 1 to 20 carbon atoms. In some aspects, each L is —CH₂CH₂CH₂—.

In some aspects, each X¹ is —OR¹.

In some aspects, each R¹ is an optionally substituted alkyl group having from 1 to 20 carbon atoms. In some aspects, each R¹ is an ethyl group.

In some aspects, b is 3.

In some aspects, d is 3.

In some aspects, the silane compound of formula (I)

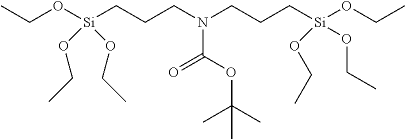 [SMILES: CCO[Si](CCCN(CCC[Si](OCC)(OCC)OCC)C(=O)OC(C)(C)C)(OCC)OCC]

is prepared by reacting the compound of formula (V)

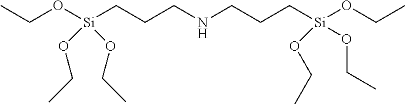 [SMILES: CCO[Si](CCCNCCC[Si](OCC)(OCC)OCC)(OCC)OCC]

with the protective agent

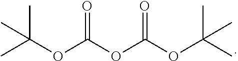

In some aspects, Q¹ is R¹, and the silane compound of formula (I)

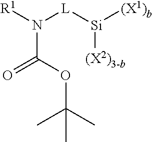

is prepared by reacting the compound of formula (V)

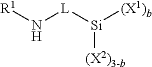

with the protective agent

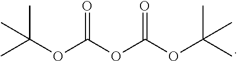

In some aspects, L is an optionally substituted alkylene group having from 1 to 20 carbon atoms. In some aspects, L is —CH₂CH₂CH₂—.

In some aspects, each X¹ is —OR¹.

In some aspects, each R¹ is independently an optionally substituted alkyl group having from 1 to 20 carbon atoms, or an optionally substituted aryl group having from 6 to 12 carbon atoms. In some aspects, R¹ is an ethyl group. In some aspects, R¹ is a methyl group. In some aspects, R¹ is a phenyl group.

In some aspects, b is 3.

In some aspects, the silane compound of formula (I)

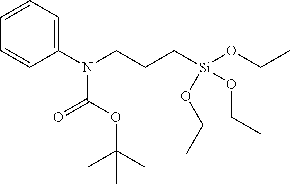 [SMILES: CCO[Si](CCCN(C(=O)OC(C)(C)C)c1ccccc1)(OCC)OCC]

is prepared by reacting the compound of formula (V)

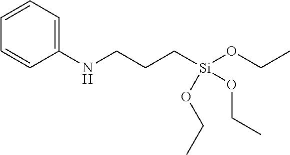 [SMILES: CCO[Si](CCCNc1ccccc1)(OCC)OCC]

with the protective agent

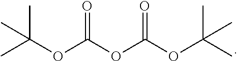

In some aspects, the silane compound of formula (I)

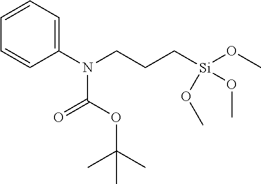 [SMILES: CO[Si](CCCN(C(=O)OC(C)(C)C)c1ccccc1)(OC)OC]

is prepared by reacting the compound of formula (V)

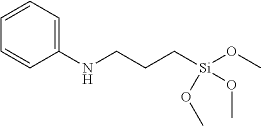 [SMILES: CO[Si](CCCNc1ccccc1)(OC)OC]

with the protective agent

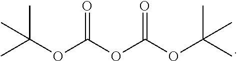

In some aspects, M is sulfur, a is 0, and the silane compound of formula (I)

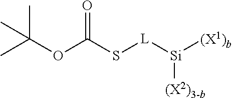

is prepared by reacting the compound of formula (V)

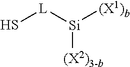

with the protective agent

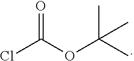

In some aspects, L is an optionally substituted alkylene group having from 1 to 20 carbon atoms. In some aspects, L is —CH₂CH₂CH₂—.

In some aspects, each X¹ is —OR¹.

In some aspects, each R¹ is an optionally substituted alkyl group having from 1 to 20 carbon atoms. In some aspects, each R¹ is an ethyl group.

In some aspects, b is 3.

In some aspects, the silane compound of formula (I)

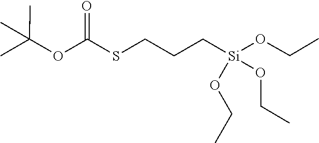 [SMILES: CCO[Si](CCCSC(=O)OC(C)(C)C)(OCC)OCC]

is prepared by reacting the compound of formula (V)

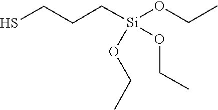

with the protective agent

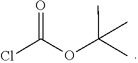

In some aspects, the protective agent is

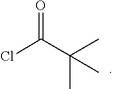

In some aspects, Y is

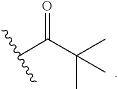 [SMILES: *C(=O)C(C)(C)C]

In some aspects, M is oxygen, a is 0, and the silane compound of formula (I)

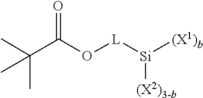

is prepared by reacting the compound of formula (V)

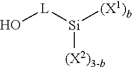

with the protective agent

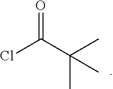

In some aspects, L is an optionally substituted alkylene group having from 1 to 20 carbon atoms. In some aspects, L is —CH₂CH₂CH₂—.

In some aspects, each X¹ is —OR¹.

In some aspects, each R¹ is an optionally substituted alkyl group having from 1 to 20 carbon atoms. In some aspects, each R¹ is an ethyl group.

In some aspects, b is 3.

In some aspects, the silane compound of formula (I)

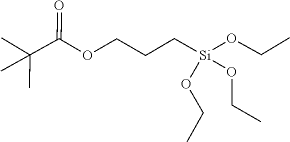 [SMILES: CCO[Si](CCCOC(=O)C(C)(C)C)(OCC)OCC]

is prepared by reacting the compound of formula (V)

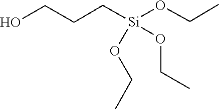

with the protective agent

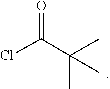

In some aspects, the reaction occurs in the presence of a base, heat, or an exothermic condition.

In some aspects, the base is selected from the group consisting of 4-dimethylaminopyridine, pyridine, sodium carbonate, sodium bicarbonate, N,N-diisopropylethylamine, and magnesium oxide. In some aspects, the base is 4-dimethylaminopyridine. In some aspects, the base is sodium carbonate. In some aspects, the base is N,N-diisopropylethylamine.

In some aspects, the reaction occurs in the presence of heat.

In some aspects, the reaction occurs in an exothermic condition.

In some aspects, the molar ratio of a compound of formula (V) to a protective agent is from about 1:1 to about 1:1.5. In some aspects, the molar ratio or a compound of formula (V) to a protective agent is about 1:1 to about 1:1.3. In some aspects, the molar ratio of a compound of formula (V) to a protective agent is about 1:1.

The disclosure also provides a method of making a polymer of formula (II)

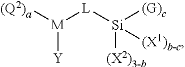

comprising reacting a chain of CC unsaturated carbon atom monomers with an anionic initiator to form a polymer fragment G; and reacting the polymer fragment G with a silane compound of formula (I)

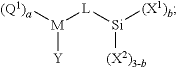

wherein:

M, Y, Q¹, each L, each X¹, each X², each R¹, a, b, and d are described as in formula (I).

Q² is -L-Si-(G)ₑ(X¹)_{d-e}(X²)_{3-d} or R¹; with the proviso that if Q¹ is -L-Si—(X¹)_{d}(X²)_{3-d}, Q² is -L-Si-(G)ₑ(X¹)_{d-e}(X²)_{3-d}; and if Q¹ is R¹, Q² is R¹;

c is 1, 2, or 3, with the proviso that c is equal to or less than b; and

e is 0, 1, 2, or 3, with the proviso that e is equal to or less than d.

In some aspects, Y is selected from the group consisting of

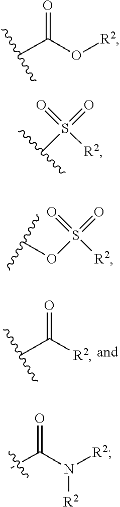

and further wherein each R² is described above.

In some aspects, Y is selected from the group consisting of

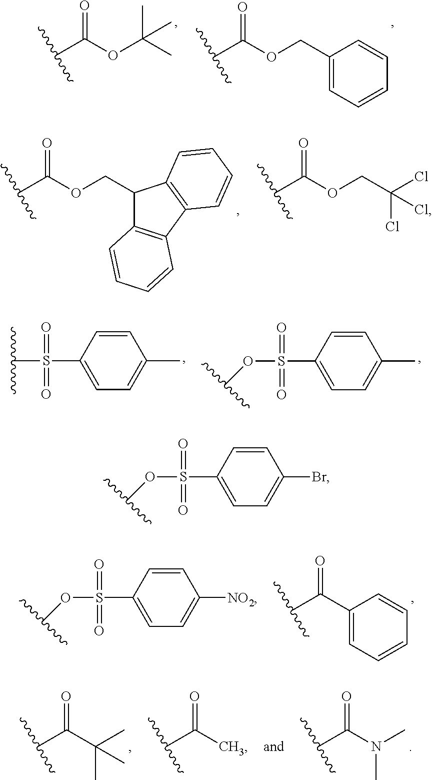

In some aspects, Y is

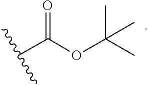 [SMILES: *C(=O)OC(C)(C)C]

In some aspects, the polymer of formula (II)

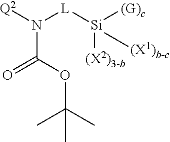

is prepared by reacting the polymer fragment G with the silane compound of formula (I)

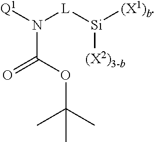

In some aspects, Q² is -L-Si-(G)ₑ(X)_{d-e}(X²)_{3-d}, Q¹ is -L-Si—(X¹)_{d}(X²)_{3-d}, and the polymer of formula (II)

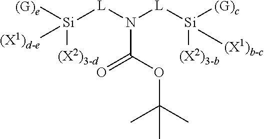

is prepared by reacting the polymer fragment G with the silane compound of formula (I)

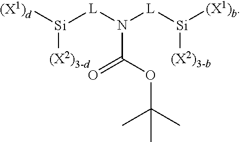

In some aspects, each L is an optionally substituted alkylene group having from 1 to 20 carbon atoms. In some aspects, each L is —CH₂CH₂CH₂—.

In some aspects, each X¹ is —OR¹.

In some aspects, each R¹ is an optionally substituted alkyl group having from 1 to 20 carbon atoms. In some aspects, each R¹ is an ethyl group.

In some aspects, c is 1.

In some aspects, b is 3.

In some aspects, e is 1.

In some aspects, d is 3.

In some aspects, the polymer of formula (II)

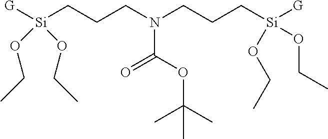

is prepared by reacting the polymer fragment G with the silane compound of formula (I)

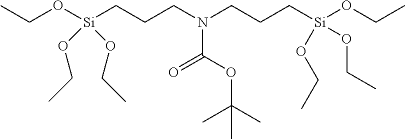 [SMILES: CCO[Si](CCCN(CCC[Si](OCC)(OCC)OCC)C(=O)OC(C)(C)C)(OCC)OCC]

In some aspects, Q² is R¹, Q¹ is R¹, and the polymer of formula (II)

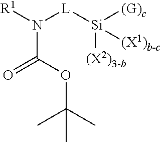

is prepared by reacting the polymer fragment G with the silane compound of formula (I)

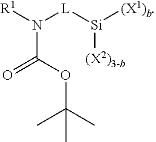

In some aspects, L is an optionally substituted alkylene group having from 1 to 20 carbon atoms. In some aspects, L is —CH₂CH₂CH₂—.

In some aspects, each X¹ is —OR¹.

In some aspects, each R¹ is independently an optionally substituted alkyl group having from 1 to 20 carbon atoms, or an optionally substituted aryl group having from 6 to 12 carbon atoms. In some aspects, R¹ is an ethyl group. In some aspects, R¹ is a methyl group. In some aspects, R¹ is a phenyl group.

In some aspects, c is 1.

In some aspects, b is 3.

In some aspects, the polymer of formula (II)

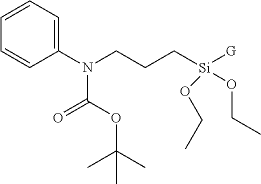

is prepared by reacting the polymer fragment G with the silane compound of formula (I)

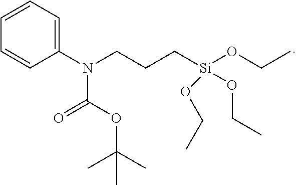 [SMILES: CCO[Si](CCCN(C(=O)OC(C)(C)C)c1ccccc1)(OCC)OCC]

In some aspects, the polymer of formula (II)

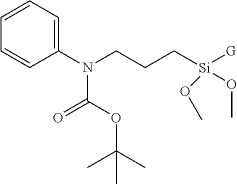

is prepared by reacting the polymer fragment G with the silane compound of formula (I)

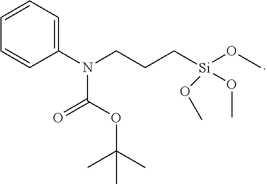 [SMILES: CO[Si](CCCN(C(=O)OC(C)(C)C)c1ccccc1)(OC)OC]

In some aspects, M is sulfur, a is 0, and the polymer of formula (II)

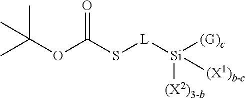

is prepared by reacting the polymer fragment G with the silane compound of formula (I)

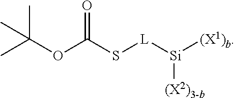

In some aspects, L is an optionally substituted alkylene group having from 1 to 20 carbon atoms. In some aspects, L is —CH₂CH₂CH₂—.

In some aspects, each X¹ is —OR¹.

In some aspects, each R¹ is an optionally substituted alkyl group having from 1 to 20 carbon atoms. In some aspects, each R¹ is an ethyl group.

In some aspects, c is 1.

In some aspects, b is 3.

In some aspects, the polymer of formula (II)

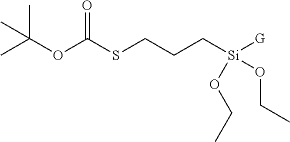

is prepared by reacting the polymer fragment G with the silane compound of formula (I)

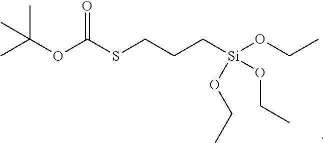 [SMILES: CCO[Si](CCCSC(=O)OC(C)(C)C)(OCC)OCC]

In some aspects, Y is

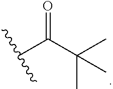 [SMILES: *C(=O)C(C)(C)C]

In some aspects, M is oxygen, a is 0, and the polymer of formula (II)

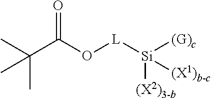

is prepared by reacting the polymer fragment G with the silane compound of formula (I)

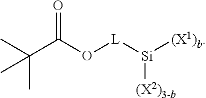

In some aspects, L is an optionally substituted alkylene group having from 1 to 20 carbon atoms. In some aspects, L is —CH₂CH₂CH₂—.

In some aspects, each X¹ is —OR¹.

In some aspects, each R¹ is an optionally substituted alkyl group having from 1 to 20 carbon atoms. In some aspects, each R¹ is an ethyl group.

In some aspects, c is 1.

In some aspects, b is 3.

In some aspects, the polymer of formula (II)

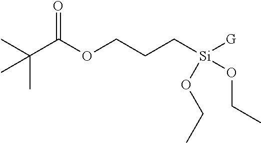

is prepared by reacting the polymer fragment G with the silane compound of formula (I)

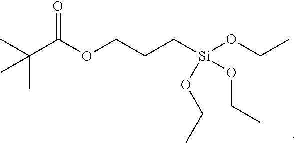 [SMILES: CCO[Si](CCCOC(=O)C(C)(C)C)(OCC)OCC]

In some aspects, the anionic initiator is n-butyllithium.

In some aspects, the ratio between the anionic initiator and the monomers is from about 1:1 to about 1:10,000, from about 1:10 to about 1:9,000, from about 1:50 to about 1:8,000, from about 1:100 to about 1:7,000, from about 1:200 to about 1:6,000, from about 1:300 to about 1:5,000, from about 1:400 to about 1:4,000, from about 1:500 to about 1:3,000, from about 1:600 to about 1:2,000, from about 1:700 to about 1:1,000, and from about 1:800 to about 1:900.

In some aspects, ratio between the anionic initiator and the silane compound of formula (I) is from about 10:1 to about 1:1, from about 9:1 to about 1:1, from about 8:1 to about 1:1, from about 6:1 to about 1:1, from about 5:1 to about 1:1, from about 4:1 to about 1:1, and from about 3:1 to about 1:1. In some aspects, the ratio between the anionic initiator and the silane compound of formula (I) is about 2:1. In some aspects, the ratio between the anionic initiator and the silane compound of formula (I) is about 1:1.

The disclosure further provides a method of making a polymer of formula (III)

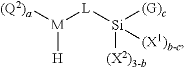

comprising reacting a polymer of formula (II)

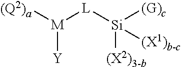

under suitable conditions, wherein:

M, Y, each L, each X¹, each X², each R¹, a, b, and d are described as in formula (I).

Q² is -L-Si-(G)ₑ(X¹)_{d-e}(X²)_{3-d} or R¹;

G is a polymer fragment having a backbone of carbon atoms covalently bonded together by C—C single bond, C—C double bond or a combination of C—C single bonds and C—C double bonds;

c is 1, 2, or 3, with the proviso that c is equal to or less than b; and

e is 0, 1, 2, or 3, with the proviso that e is equal to or less than d.

In some aspects, Y is selected from the group consisting of

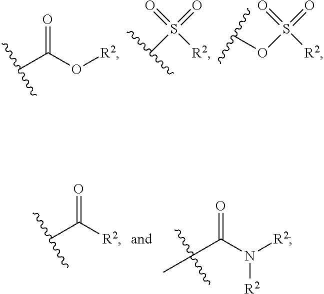

and further wherein each R² is described above.

In some aspects, Y is selected from the group consisting of

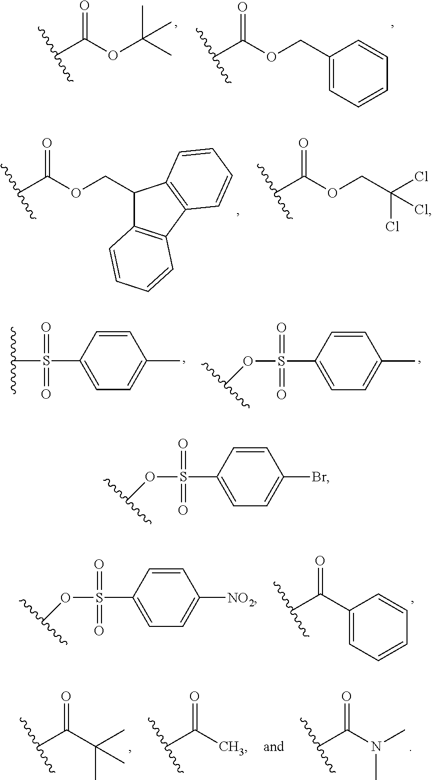

In some aspects, Y is

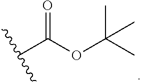 [SMILES: *C(=O)OC(C)(C)C]

In some aspects, M is nitrogen, a is 1, and the polymer of formula (III)

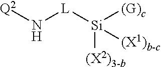

is prepared by reacting the polymer of formula (II)

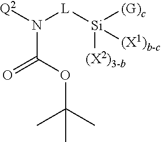

under suitable conditions.

In some aspects, Q² is -L-Si-(G)ₑ(X¹)_{d-e}(X²)_{3-d}, and the polymer of formula (III)

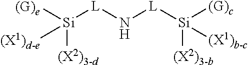

is prepared by reacting the polymer of formula (II)

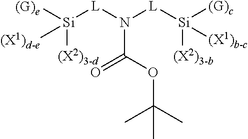

under suitable conditions.

In some aspects, each L is an optionally substituted alkylene group having from 1 to 20 carbon atoms. In some aspects, each L is —CH₂CH₂CH₂—.

In some aspects, each X¹ is —OR¹.

In some aspects, each R¹ is an optionally substituted alkyl group having from 1 to 20 carbon atoms. In some aspects, each R¹ is an ethyl group.

In some aspects, c is 1.

In some aspects, b is 3.

In some aspects, e is 1.

In some aspects, d is 3.

In some aspects, the polymer of formula (III)

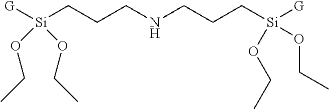

is prepared by reacting the polymer of formula (II)

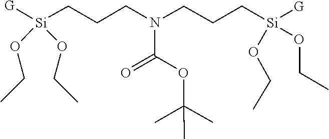

under suitable conditions.

In some aspects, Q² is R¹, and the polymer of formula (III)

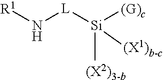

is prepared by reacting the polymer of formula (II)

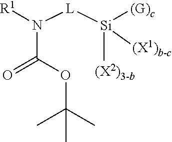

under suitable conditions.

In some aspects, L is an optionally substituted alkylene group having from 1 to 20 carbon atoms. In some aspects, L is —CH₂CH₂CH₂—.

In some aspects, each X¹ is —OR¹.

In some aspects, each R¹ is independently an optionally substituted alkyl group having from 1 to 20 carbon atoms, or an optionally substituted aryl group having from 6 to 12 carbon atoms. In some aspects, R¹ is an ethyl group. In some aspects, R¹ is a methyl group. In some aspects, R¹ is a phenyl group

In some aspects, c is 1.

In some aspects, b is 3.

In some aspects, the polymer of formula (III)

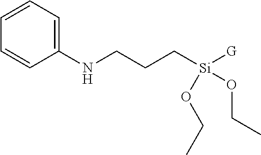

is prepared by reacting the polymer of formula (II)

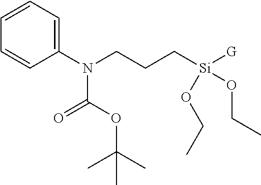

under suitable conditions.

In some aspects, the polymer of formula (III)

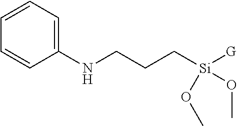

is prepared by reacting the polymer of formula (II)

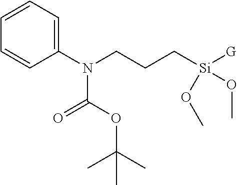

under suitable conditions.

In some aspects, M is sulfur, a is 0, and the polymer of formula (III)

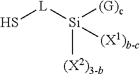

is prepared by reacting the polymer of formula (II)

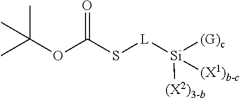

under suitable conditions.

In some aspects, L is an optionally substituted alkylene group having from 1 to 20 carbon atoms. In some aspects, L is —CH₂CH₂CH₂—.

In some aspects, each X¹ is —OR¹.

In some aspects, each R¹ is an optionally substituted alkyl group having from 1 to 20 carbon atoms. In some aspects, each R¹ is an ethyl group.

In some aspects, c is 1.

In some aspects, b is 3.

In some aspects, the polymer of formula (III)

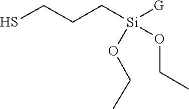

is prepared by reacting the polymer of formula (II)

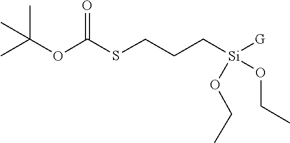

under suitable conditions.

In some aspects, Y is

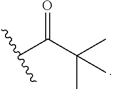 [SMILES: *C(=O)C(C)(C)C]

In some aspects M is oxygen, a is 0, and the polymer of formula (III)

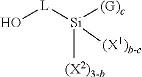

is prepared by reacting the polymer of formula (II)

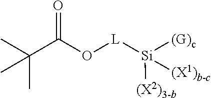

under suitable conditions.

In some aspects, L is an optionally substituted alkylene group having from 1 to 20 carbon atoms. In some aspects, L is —CH₂CH₂CH₂—.

In some aspects, each X¹ is —OR¹.

In some aspects, each R¹ is an optionally substituted alkyl group having from 1 to 20 carbon atoms. In some aspects, each R¹ is an ethyl group.

In some aspects, c is 1.

In some aspects, b is 3.

In some aspects, the polymer of formula (III)

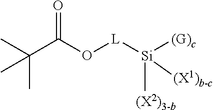

is prepared by reacting the polymer of formula (II)

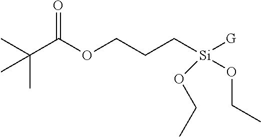

under suitable conditions.

In some aspects, the reaction occurs in the presence of a base, an acid, heat, or free radical. In some aspects, the reaction occurs in the presence of a base. In some aspects, the base is selected from the group consisting of sodium hydroxide, sodium methoxide, sodium ethoxide, potassium carbonate, potassium tert-butoxide, aluminium oxide, diisobutylaluminium hydride, methyllithium, lithium hydroxide, lithium methoxide, lithium ethoxide, tetrabutylammonium hydroxide, methylamine, and ethylmagnesium bromide. In some aspects, the reaction occurs in the presence of an acid. In some aspects, the acid is selected from the group consisting of stearic acid, hydrochloric acid, hydrobromic acid, and trifluoroacetic acid. In some aspects, the acid is hydrochloric acid. In some aspects, the acid is trifluoroacetic acid. In some aspects, the acid is stearic acid. In some aspects, the reaction occurs in the presence of heat. In some aspects, the reaction occurs in the presence of free radical. In some aspects, the free radical is organic or inorganic radical species.

In some aspects, the polymer fragment G is described above.

The disclosure relates to a composition comprising one or more polymers described above.

The disclosure further relates to a composition comprising one or more polymers prepared by the method described above.

The disclosure provides a rubber composition comprising the composition described above.

The disclosure further provides a rubber composition comprising:

(i) about 100 parts of rubber, where the weight of the rubber is the sum of the weights of each (a) diene-based polymer containing at least one functional group, (b) diene-based polymer containing no functional group and (c) a diene-based polymer containing at least one functional group which is formula II and/or formula III
(iii) about 5 to about 140 parts by weight per 100 parts rubber (i) of silica;
(iv) about 0.1 to about 10 parts by weight per 100 parts rubber (i) of at least one process aid; and
(v) about 0.1 to about 20 parts by weight per 100 parts rubber (i) of a vulcanization package comprising at least one vulcanizing agent comprising sulfur and at least one accelerator.

In some aspects, the diene-based polymer is a diene-based polymer containing at least one functional group, a diene-based polymer containing no functional group, or combinations thereof.

In some aspects, the diene-based polymer is natural rubber, styrene-butadiene rubber, cis 1,4-polyisoprene, cis 1,4-polybutadiene, trans 1,4-polybutadiene, 1,2-polybutadiene, or combinations thereof.

In some aspects, the process aid is 2,2,4-trimethyl-1,2-dihydroquinoline, N-(1,3-Dimethylbutyl)-N′-phenyl-p-phenylenediamine, octyl triethoxysilane, a triethoxysilylated hydrocarbon, zinc stearate, steric acid, zinc soaps of fatty acids, paraffin wax, microcrystalline wax, paraffinic process oil, naphthenic process oil, aromatic process oil, or combinations thereof.

In some aspects, the sulfur in the vulcanizing agent is selected from the group consisting of elemental sulfur, sulfur-donating compounds, and combinations thereof.

In some aspects, the accelerator is selected from the group consisting of benzothiazoles, guanidine derivatives, thiocarbamates, and combinations thereof.

In some aspects, the accelerator is selected from the group consisting of mercapto benzothiazole, benzothiazole disulfide, diphenylguanidine, zinc dithiocarbamate, alkylphenoldisulfide, zinc butyl xanthate, N-dicyclohexyl-2-benzothiazolesulfenamide, N-cyclohexyl-2-benzothiazolesulfenamide, N-oxydiethylenebenzothiazole-2-sulfenamide, N,N-diphenylthiourea, dithiocarbamylsulfenamide, N,N-diisopropylbenzothiozole-2-sulfenamide, zinc-2-mercaptotoluimidazole, dithiobis(N-methyl piperazine), dithiobis(N-beta-hydroxy ethyl piperazine), dithiobis(dibenzyl amine), and combinations thereof.

In some aspects, the rubber composition further comprises at least one filler. In some aspects, the filler is selected from the group consisting of titanium dioxide, alumina, aluminosilicates, siliceous materials, carbon black, acetylene black, calcium carbonate, barium sulfate, and combinations thereof.

In some aspects, the rubber composition further comprises at least one process oil. In some aspects, the process oil is treated distillate aromatic extracted (TDAE) oil.

In some aspects, the rubber composition further comprises at least one activator. In some aspects, the activator is zinc oxide or stearic acid.

In some aspects, the rubber composition further comprises at least one antidegradant. In some aspects, the antidegradant is N-(1,3-dimethylbutyl)-N′-phenyl-p-phenylenediamine. In some aspects, the antidegradant is 2,2,4-trimethyl-1,2-dihydroquinoline polymer or a microcrystalline wax.

The disclosure further provides to an article of manufacture comprising the rubber composition described above. In some aspects, the article of manufacture includes but is not limited to a tire, a conveyor belt, an engine mount, a shoe sole, a tubing, a glove, a windshield wiper, a brake pad, an eraser, a rubber band, a grip, a brayer, a flame retardant, and a polishing pad.

### EXAMPLES

Having now generally described this invention, the same will be understood by reference to the following examples which are provided herein for purposes of illustration only and are not intended to be limiting unless otherwise specified.

### Example 1

### Preparation of Aminosilane 1

A three neck round bottom flask was equipped with a magnetic stirrer, a temperature probe, an addition funnel, and a nitrogen inlet. Di-tert-butyldicarbonate (75.05 g, 0.34 moles) was added in the three neck round bottom flask. Then bis-(3-triethoxysilylpropyl)amine (121.8 g, 0.29 moles) was added to the flask via the addition funnel over a period of 30 minutes, starting at ambient temperature under nitrogen protection. The product of the reaction was stripped and then distilled by a Kugelrohr apparatus at 0.02 mmHg and 140-158° C. temperature. 102.44 grams of Aminosilane 1 with a GC purity of 97.36% was recovered, and characterized ¹H NMR. ¹H NMR (CDCl₃, 600 MHz): δH 3.83-3.77 (12H), 3.23-3.11 (4H), 1.79-1.66 (4H), 1.44 (9H), 1.30-1.17 (18H), 0.65-055 (4H).

### Example 2

### Preparation of Aminosilane 2

A three neck round bottom flask was equipped with a magnetic stirrer, a temperature probe, an addition funnel, and a nitrogen inlet. Di-tert-butyldicarbonate (135.2 g, 0.62 moles) and acetonitrile (111.8 g) were added in the flask. Then N-phenyl-3-aminopropyltrimethoxysilane (123.4 g, 0.48 moles) was added in the flask. 4-Dimethylaminopyridine (0.1 g) was subsequently added to the mixture at ambient temperature. The product of the reaction was stripped and then distilled by a Kugelrohr apparatus at 0.02 mmHg and 117.8° C. temperature. 131.07 grams of Aminosilane 2 with a GC purity of 95.6% was recovered, and characterized by ¹H NMR. ¹H NMR (CDCl₃, 600 MHz): δH 7.38-7.30 (2H), 7.22-7.16 (3H), 3.62-3.59 (2H), 3.60-3.57 (9H), 1.77-1.64 (2H), 1.43 (9H), 0.61-0.59 (2H).

### Example 3

### Preparation of Aminosilane 3

A three neck round bottom flask was equipped with a magnetic stirrer, a temperature probe, an addition funnel, and a nitrogen inlet. Di-tert-butyldicarbonate (50.7 g, 0.23 moles) and acetonitrile (49.4 g) were added in the flask. Then N-phenyl-3-aminopropyltriethoxysilane (60.2 g, 0.20 moles) was added in the flask. 4-Dimethylaminopyridine (0.1 g) was subsequently added to the mixture at ambient temperature. The product of the reaction was stripped and then distilled by a Kugelrohr apparatus at 0.02 mmHg and 115-125° C. temperature. 66.82 grams of Aminosilane 3 with a GC purity of 91.5% was recovered, and characterized by ¹H NMR. (CDCl₃, 600 MHz): δH 7.38-7.30 (2H), 7.22-7.16 (3H), 3.83-3.77 (6H), 3.62-3.59 (2H), 1.77-1.66 (2H), 1.43 (9H), 1.30-1.18 (9H). 0.61-0.57 (2H).

### Example 4

### Preparation of Thiosilane 1

A three neck round bottom flask was equipped with a magnetic stirrer, a temperature probe, an addition funnel, and a nitrogen inlet. Di-tert-butlydicarbonate (0.23 moles) and acetonitrile (50.0 g) were added in the flask. Then (3-mercaptopropyl)triethoxysilane (0.20 moles) was added in the flask. Sodium carbonate (0.1 g) was subsequently added to the mixture at ambient temperature. The reaction mixture was heated to 28° C. over 1 hr. The product of the reaction was purified by distilling out the excess di-tert-butlydicarbonate at 50-55° C. at 0.5 mmHg and thiosilane 1 at 90° C. at 0.5 mmHg. Thiosilane 1 was recovered, and characterized by and ¹H NMR, ²⁹Si NMR.

¹H NMR (CDCl₃, 400 MHz): δH 3.76-3.69 (6H, q), 3.57-3.55 (2H, t), 1.70-1.65 (2H, q), 1.50 (9H, s), 1.10-1.05 (9H, t) 0.702-0.65 (2H, t).

²⁹Si NMR (CDCl₃, 79 MHz): δ-45.14.

### Example 5

### Preparation of Unfunctionalized SSBR

The anionic polymerization initiated by n-butyl lithium is very sensitive to moisture, so the following precautions were taken to make sure that the polymerization happens properly without the initiator getting quenched. Initially, the monomers styrene and 1,3-butadiene were stirred separately for 2 hr in basic alumina (to remove the inhibitor) and 3 Å molecular sieves (to scavenge the moisture). All the glassware was dried in an oven at 150° C. and assembled hot, with all open ports covered. A four neck round bottom flask was set up with a condenser, an addition funnel, a thermometer pocket, and a silicone septum port for adding an initiator via syringe. The flask was used with a heating mantle and a stirrer. The flask was dried. Then the flask was purged with nitrogen and vacuumed for 10 mins each for 3 times.

The flask was charged with toluene (218 mL), 1,3-butadiene (15 wt % in hexane) (140.22 g, 2.59 mol), styrene (30 g, 0.288 mol) and tetrahydrofuran (23.9 ml) through the molecular sieves packed addition funnel. Then n-butyllithium (2M solution in cyclohexane) (0.92 g, 0.014 mol) was added by syringe under nitrogen, and added in one shot to the reaction mixture. The reaction mixture was heated from room temperature to 50° C. in 5 mins. The reaction took place at 50° C. for 4 hours. No precipitation was observed during the polymerization. The reaction system was homogeneous and transparent from the beginning to the completion of polymerization.

After the completion of polymerization, the reaction mixture was quenched with methanol. Then the heating was stopped and the reaction mixture was cooled to room temperature. The solvent evaporated under vacuum by rotavapor at ˜55° C. to obtain unfunctionalized SBR. Further, the volatiles were stripped at 70° C. under high vacuum for about 5 hours to obtain the rubbery polymer. The sample was characterized by ¹HNMR, and GPC.

¹H NMR (CDCl₃, 400 MHz): δH 7.36-6.95 (9H, m), 5.73-5.13 (18H, m), 5.12-4.63 (18H, m), 2.73-0.745 (53H, m).

GPC: Mn=27440 g/mol.

### Example 6

### Preparation of Aminosilane 1 Functionalized SSBR

The flask was charged with toluene (218 mL), 1,3-butadiene (15 wt % in hexane) (140.22 g, 2.59 mol), styrene (30 g, 0.288 mol) and tetrahydrofuran (23.9 ml) through the molecular sieves packed addition funnel. Then n-butyllithium (2M solution in cyclohexane) (0.92 g, 0.014 mol) was added by syringe under nitrogen, and added in one shot to the reaction mixture. The reaction mixture was heated from room temperature to 50° C. in 5 mins. The reaction took place at 50° C. for 4 hours. No precipitation was observed during the polymerization. The reaction system was homogeneous and transparent from the beginning to the completion of polymerization.

After the completion of polymerization, Carbamic acid, N,N-bis[3-(triethoxysilyl)propyl]-1,1-dimethylethyl ester (Aminosilane 1) (3.8 g, 0.007 mol) was further added into the flask as a coupling agent. The reaction took overnight to complete the end capping. Then the heating was stopped and the reaction mixture cooled to room temperature. The solvent was evaporated under vacuum by rotavapor at ˜55° C. to obtain Aminosilane 1 functionalized SBR. Further, the volatiles were stripped at 70° C. under high vacuum for about 5 hours to obtain a rubbery polymer. The sample was characterized by ¹HNMR, ²⁹Si NMR, and GPC. ¹H NMR (CDCl₃, 400 MHz): δH 7.32 6.98 (18H, m), 5.89-5.11 (29H, m), 5.09-4.64 (28H, m), 3.90-3.56 (12H, m), 3.24-3.02 (4H, m), 2.73-2.48 (3H, m) 2.32-0.363 (170H, m).
²⁹Si NMR (CDCl₃, 79 MHz): δ 10.01 , −10.980.
GPC: Mn=26040 g/mol.

### Example 7

### Preparation of Aminosilane 2 Functionalized SSBR

The flask was charged with toluene (32 mL), 1,3-butadiene (15 wt % in hexane) (10.28 g, 0.19 mol), styrene (2.20 g, 0.021 mol) and tetrahydrofuran (3.5 ml) through the molecular sieves packed addition funnel. Then n-butyllithium (2M solution in cyclohexane) (0.135 g, 0.0021 mol) was added by syringe under nitrogen, and added in one shot to the reaction mixture. The reaction mixture was heated from room temperature to 50° C. in 5 mins. The reaction took place at 50° C. for 4 hours. No precipitation was observed during the polymerization. The reaction system was homogeneous and transparent from the beginning to the completion of polymerization.

After the completion of polymerization, carbamic acid, N-phenyl-N-[3-(trimethoxysilyl)propyl]-1,1-dimethylethyl ester (aminosilane 2) (0.7 g, 0.002 mol) was further added into the flask as a coupling agent. The reaction took overnight to complete the end capping. Then the heating was stopped, and the reaction mixture was cooled to room temperature. The solvent evaporated under vacuum by rotavapor at ˜55° C. to obtain Aminosilane 2 functionalized SBR. Further, the volatiles were stripped at 70° C. under high vacuum for about 5 hours to obtain a rubbery polymer. The sample was characterized by ¹HNMR, and ²⁹Si NMR, H NMR (CDCl₃, 400 MHz): δH 7.54-6.98 (177H, m), 5.84-5.26 (146H, m), 5.21-4.72 (183H, m), 3.92-3.51 (9H, m), 2.61-0.963 (520H, m). ²⁹Si NMR (CDCl₃, 79 MHz): δ 9.84 , −21.82.

### Example 8

### Preparation of Aminosilane 3 Functionalized SSBR

The flask was charged with toluene (32 mL), 1,3-butadiene (15 wt % in hexane) (10.28 g, 0.19 mol), styrene (2.20 g, 0.021 mol) and tetrahydrofuran (3.5 ml) through the molecular sieves packed addition funnel. Then n-butyllithium (2M solution in cyclohexane) (0.135 g, 0.0021 mol) was added by syringe under nitrogen, and added in one shot to the reaction mixture. The reaction mixture was heated from room temperature to 50° C. in 5 mins. The reaction took place at 50° C. for 4 hours. No precipitation was observed during the polymerization. The reaction system was homogeneous and transparent from the beginning to the completion of polymerization.

After the completion of polymerization, carbamic acid, N-phenyl-N-[3-(triethoxysilyl)propyl]-1,1-dimethylethyl ester (Aminosilane 3) (0.8 g, 0.002 mol) was further added into the flask as a coupling agent. The reaction took overnight to complete the end capping. Then the heating was stopped, and the reaction mixture was cooled to room temperature. The solvent evaporated under vacuum by rotavapor at ˜55° C. to obtain Aminosilane 3 functionalized SBR. Further, the volatiles were stripped at 70° C. under high vacuum for about 5 hours to obtain a rubbery polymer. The sample was characterized by ¹HNMR, and ²⁹Si NMR.

¹H NMR (CDCl₃, 400 MHz): δH 7.43-6.809 (168H, m), 5.74-5.12 (79H, m), 5.093-4.607 (93H, m), 3.893-3.60 (6H, m), 2.758-0.814 (359H, m).

²⁹Si NMR (CDCl₃, 79 MHz): δ-21.82 , −45.30.

### Example 9

### Preparation of Thiosilane 1 Functionalized SSBR

The flask was charged with toluene (32 mL), 1,3-butadiene (15 wt % in hexane) (10.28 g, 0.19 mol), styrene (2.20 g, 0.021 mol) and tetrahydrofuran (3.5 ml) through the molecular sieves packed addition funnel. Then n-butyllithium (2M solution in cyclohexane) (0.135 g, 0.0021 mol) was added by syringe under nitrogen, and added in one shot to the reaction mixture. The reaction mixture was heated from room temperature to 50° C. in 5 mins. The reaction took place at 50° C. for 4 hours. No precipitation was observed during the polymerization. The reaction system was homogeneous and transparent from the beginning to the completion of polymerization.

After the completion of polymerization, O-(tert-butyl) S-(3-(triethoxysilyl)propyl) carbonothioate (Thiosilane 1) (0.68 g, 0.002 mol) was further added into the flask as a coupling agent. The reaction took overnight to complete the end capping. Then the heating was stopped and the reaction mixture cooled to room temperature. The solvent evaporated under vacuum by rotavapor at ˜55° C. to obtain thiosilane 1 functionalized SBR. Further, the volatiles were stripped at 70° C. under high vacuum for about 5 hours to obtain a rubbery polymer. The sample was characterized by ¹HNMR, and ²⁹Si NMR.

¹H NMR (CDCl₃, 400 MHz): δH 7.20-6.809 (30H, m), 5.89-5.04 (45H, m), 4.93-4.207 (42H, m), 3.93-3.60 (6H, m), 2.758-0.814 (180H, m).

²⁹Si NMR (CDCl₃, 79 MHZ): δ-21.90 , −46.00 , −51.17.

### Example 10

### Preparation of Deprotected Aminosilane 1 Functionalized SSBR

The flask is charged with toluene (200 mL), tetrahydrofuran (25 ml), aminosilane 1 functionalized SBR (180 g), and hydrochloric acid (2M aqeous solution) (0.007 mol, 3.5 mL). The reaction takes place at 65° C. for 2 hours. Then the heating is stopped and the reaction mixture cools to room temperature. The solvent evaporates under vacuum by rotavapor at ˜55° C. to obtain deprotected Aminosilane 1 functionalized SBR. Further, the volatiles are stripped at 70° C. under high vacuum for about 5 hours to obtain a rubbery polymer. The sample is characterized by ¹HNMR, ¹³CNMR, ²⁹Si NMR, FTIR, TGA and GPC.

### Example 11

### Preparation of Deprotected Aminosilane 2 Functionalized SSBR

The flask is charged with toluene (35 mL), tetrahydrofuran (5 ml), aminosilane 2 functionalized SBR (14 g), and hydrochloric acid (2M aqeous solution) (0.002 mol, 1 mL). The reaction takes place at 65° C. for 2 hours. Then the heating is stopped and the reaction mixture cools to room temperature. The solvent evaporates under vacuum by rotavapor at ˜55° C. to obtain deprotected aminosilane 2 functionalized SBR. Further, the volatiles are stripped at 70° C. under high vacuum for about 5 hours to obtain a rubbery polymer. The sample is characterized by ¹HNMR, ¹³CNMR, ²⁹Si NMR, FTIR, TGA and GPC.

### Example 12

### Preparation of Deprotected Aminosilane 3 Functionalized SSBR

The flask is charged with toluene (35 mL), tetrahydrofuran (5 ml), Aminosilane 3 functionalized SBR (14 g), and hydrochloric acid (2M aqeous solution) (0.002 mol, 1 mL). The reaction takes place at 65° C. for 2 hours. Then the heating is stopped and the reaction mixture cools to room temperature. The solvent evaporates under vacuum by rotavapor at ˜55° C. to obtain deprotected Aminosilane 3 functionalized SBR. Further, the volatiles are stripped at 70° C. under high vacuum for about 5 hours to obtain a rubbery polymer. The sample is characterized by ¹HNMR, ¹³CNMR, ²⁹Si NMR, FTIR, TGA and GPC.

### Example 13

### Preparation of Deprotected Thiosilane 1 Functionalized SSBR

The flask is charged with toluene (35 mL), tetrahydrofuran (5 ml), Thiosilane 1 functionalized SBR (14 g), and hydrochloric acid (2M aqeous solution) (0.002 mol, 1 mL). The reaction takes place at 65° C. for 2 hours. Then the heating is stopped and the reaction mixture cools to room temperature. The solvent evaporates under vacuum by rotavapor at ˜55° C. to obtain deprotected Thiosilane 1 functionalized SBR. Further, the volatiles are stripped at 70° C. under high vacuum for about 5 hours to obtain a rubbery polymer. The sample is characterized by ¹HNMR, ¹³CNMR, ²⁹Si NMR, FTIR, TGA and GPC.

### Example 14

### Preparation of Deprotected Aminosilane 3 Functionalized SSBR

A flask was charged with dichloromethane (5 mL), Aminosilane 3 functionalized SBR (0.25 g), and trifluoro acetic acid (0.002 mol, 1 mL). The reaction proceeded at room temperature for 1 hour. The solvent was evaporated under vacuum by rotary evaporator at ˜55° C. to obtain deprotected aminosilane 3 functionalized SBR. Further, the sample was stripped at 60° C. under high vacuum for about 4 hours to obtain a rubbery polymer. The sample was characterized by ¹HNMR and FTIR. The FTIR clearly showed the disappearance of the carbonyl peak at 1699 cm⁻¹, indicating the deprotection of the Boc protecting group.

### Example 15

### Preparation of Aminosilane 4

250.17 g bis(trimethoxysilylpropyl)amine (available from Momentive Performance Materials as Silquest A-1170, 0.73 moles), 72.08 g dimethylcarbonate (0.80 moles), and 6.5 g of sodium methoxide solution (25% in methanol) were charged into a 500 mL round bottom flask equipped with magnetic stir bar, heating mantle, temperature probe, and short path distillation head. The mixture was heated to 80-90° C. for a total of 54 hours. The subsequent product mixture was neutralized with 2.42 g glacial acetic acid, filtered, stripped, and distilled. Aminosilane 4 was collected as the fraction which distilled between 141-143° C. at 0.1-0.2 mm Hg. Aminosilane 4 was characterized by GC/MS.

### Example 16

### Procedure for Rubber Compounding

TABLE 1 lists the ingredients used for preparing the rubber compositions using an 75/25 blend of non-functionalized solution polystyrene-butadiene (SSBR)/Cis 1,4-polybutadiene and contains 15 parts of non-functionalized SBR oligomer (Comparative Example 5 (Comparative EX 5)) or functionalized SBR oligomer (Example 6 (EX 6)). The two formulations were mixed in an internal rubber mixer utilizing a mixing procedure involving two non-productive mixing steps followed by a final productive mix. The silica formulation was heat-treated (to drive the needed silanization reaction) for about 110 secs at 150° C. during the two non-productive passes. The two formulations were mixed with curatives in the final productive mix for 180 seconds at 105° C. The rubber compositions shown in TABLE 1 were cured at 160° C. for 20 minutes.

TABLE 1
Ingredients for Rubber Compositions

| | Comparative EX 5 | EX 6 |
|---|---|---|
| Buna SL4525 (non-func SSBR) | 75 | 75 |
| Kibipol HBR PR-040G (BR) | 25 | 25 |
| Zeosil 1165MP (Silica) | 80 | 80 |
| Carbon Black (CB) | 5 | 5 |
| Process Oil (TDAE) | 7.5 | 7.5 |
| 6PPD (AO) | 2 | 2 |
| TMQ (AO) | 1 | 1 |
| MC wax (AO) | 2 | 2 |
| NXT | 6.4 | 6.4 |
| ZnO (Activator) | 2.5 | 2.5 |
| Stearic Acid (Activator) | 2 | 2 |
| Example 5 | 7.5 | |
| Example 6 | | 7.5 |
| NP1 Total | 215.9 | 215.9 |
| — | — | — |
| NP2 Total | 215.9 | 215.9 |
| — | — | — |
| Sulfur | 2 | 2 |
| CBS (Accelerator) | 2.5 | 2.5 |
| DPG (Accelerator) | 2 | 2 |
| FM Total | 222.4 | 222.4 |

The resulting physical and dynamic properties are shown in TABLE 2. The modulus and tensile/elongation were measured with Zwick/Roell Ring tester and followed ASTM D412; The rebound was tested on Zwick/Roell 5109 Rebound Machine and followed ASTM D7121-05; Shore A was measured with Zwick/Roell Durometer and followed ASTM D-2240-15; RPA modulus was measured on RPA 2000 at 60° C., 10 Hz, and under 10% of deformation. The hysteresis was measured with Metravib 1000+ DMA and the values were taken from 0° C. and 60° C., at 10 Hz during a temperature sweep.

TABLE 2
Resulting Properties of Rubber Compositions

| Rubber | | | Comparative | |
|---|---|---|---|---|
| Property | Measurement | Units | Ex Y | Ex X |
| Wear | 50% Modulus | MPa | 2.2 | 2.2 |
| Wear | 100% Modulus | MPa | 3.7 | 3.8 |
| Wear | 300% Modulus | MPa | 14.7 | 15 |
| | RI (M300/M100) | | 4 | 4 |
| | Tensile (Peak Force) | MPa | 15.9 | 16.2 |
| | Elongation (Peak Strain) | % | 348 | 348 |
| Handling | Shore A @ 25 ° C. | shoreA | 74.3 | 74.8 |
| Handling | Shore A @ 70 ° C. | shoreA | 71.8 | 72.6 |
| Rolling | Rebound @ 70 ° C. | % | 48.2 | 48.8 |
| Resistance | | | | |
| Wear | RPA 2000 Strain Sweep @ 60° C., | MPa | 3.7 | 3 4 |
| | 10 Hz strain @ 10% | | | |
| Rolling | Metravib Temp Sweep @ 60° C., 10 | | 0.186 | 0.177 |
| Resistance | Hz Tan δ @ 10% | | | |

What is claimed is:

1. A silane compound having formula (I) 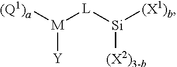
wherein:
M is selected from the group consisting of nitrogen, sulfur and oxygen;
Y is a protecting group;
Q¹ is -L-Si—(X¹)_{d}(X²)_{3-d} or R¹;
each L is independently absent, an optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, or an optionally substituted aralkylene group having from 7 to 16 carbon atoms and optionally at least one heteroatom;
each X¹ is independently —OR¹ or —OC(═O)R¹;
each X² is R¹;
each R¹ is independently selected from the group consisting of an optionally substituted alkyl group having from 1 to 20 carbon atoms and optionally at least one heteroatom, an optionally substituted alkenyl group having from 2 to 20 carbon atoms and optionally at least one heteroatom, an optionally substituted alkynyl group having from 2 to 20 carbon atoms and optionally at least one heteroatom, an optionally substituted cycloalkyl group having from 3 to 10 carbon atoms and optionally at least one heteroatom, an optionally substituted aryl group having from 6 to 12 carbon atoms and optionally at least one heteroatom, an optionally substituted aralkyl group having from 7 to 16 carbon atoms and optionally at least one heteroatom, and an optionally substituted cyclic silane; or is a divalent group formed from two R¹ groups being bonded together through a covalent bond, with the proviso that if two R¹ groups are bonded together then b is 2 or 3;
a is 0 or 1; with the proviso that if M is nitrogen, a is 1 or if M is sulfur or oxygen, a is 0;
b is 1, 2, or 3; and
d is 0, 1, 2, or 3.

2. The silane compound of claim 1, wherein Y is

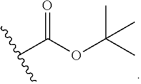 [SMILES: *C(=O)OC(C)(C)C]

3. The silane compound of claim 1, wherein each X¹ is —OR¹.

4. The silane compound of claim 1, wherein each R¹ is an optionally substituted alkyl group having from 1 to 20 carbon atoms.

5. The silane compound of claim 1, wherein
(a) when M is nitrogen, a is 1, and Y is 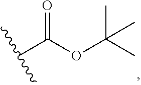 [SMILES: *C(=O)OC(C)(C)C]
the silane compound of formula (I) is 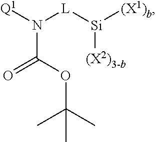
or
(b) when Q¹ is -L-Si—(X¹)_{d}(X²)_{3-d} and Y is 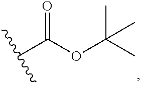 [SMILES: *C(=O)OC(C)(C)C]
the silane compound of formula (I) is 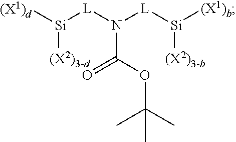
or
(c) when M is sulfur, a is 0, and Y is 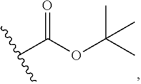 [SMILES: *C(=O)OC(C)(C)C]
the silane compound of formula (I) is

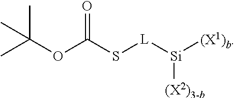

6. The silane compound of claim 1, wherein the silane compound of formula (I) is

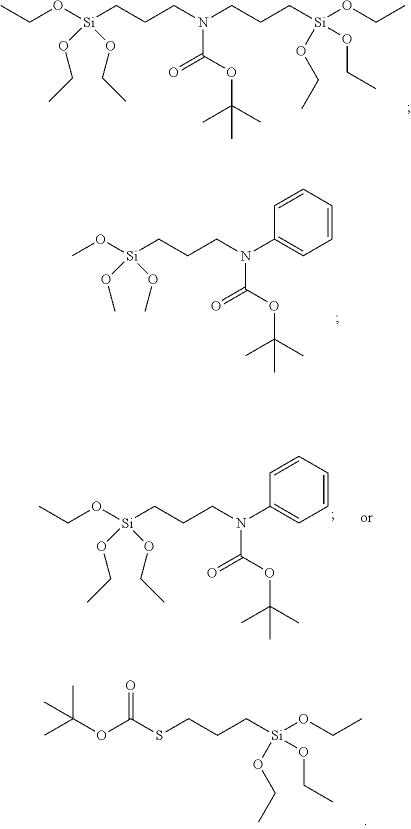

7. A polymer represented by:
(a) formula (II) 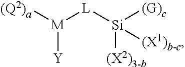
wherein:
M is selected from the group consisting of nitrogen, sulfur and oxygen;
Y is a protecting group;
Q² is -L-Si-(G)ₑ(X¹)_{d-e}(X²)_{3-d} or R¹;
each L is independently absent, an optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, or an optionally substituted aralkylene group having from 7 to 16 carbon atoms and optionally at least one heteroatom;
each X¹ is independently —OR¹ or —OC(═O)R¹;
each X² is R¹;
each R¹ is independently selected from the group consisting of an optionally substituted alkyl group having from 1 to 20 carbon atoms and optionally at least one heteroatom, an optionally substituted alkenyl group having from 2 to 20 carbon atoms and optionally at least one heteroatom, an optionally substituted alkynyl group having from 2 to 20 carbon atoms and optionally at least one heteroatom, an optionally substituted cycloalkyl group having from 3 to 10 carbon atoms and optionally at least one heteroatom, an optionally substituted aryl group having from 6 to 12 carbon atoms and optionally at least one heteroatom, an optionally substituted aralkyl group having from 7 to 16 carbon atoms and optionally at least one heteroatom, and an optionally substituted cyclic silane; or is a divalent group formed from two R¹ groups being bonded together through a covalent bond, with the proviso that if two R¹ groups are bonded together then b is 2 or 3;
G is a polymer fragment having a backbone of carbon atoms covalently bonded together by C—C single bond, C—C double bond or a combination of C—C single bonds and C—C double bonds;
a is 0 or 1; with the proviso that if M is nitrogen, a is 1 or if M is sulfur or oxygen, a is 0;
b is 1, 2, or 3;
c is 1, 2, or 3, with the proviso that c is equal to or less than b;
d is 0, 1, 2, or 3; and
e is 0, 1, 2, or 3, with the proviso that e is equal to or less than d; or
(b) formula (III) 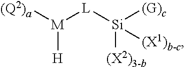
wherein
M is selected from the group consisting of nitrogen, sulfur and oxygen;
Q² is -L-Si-(G)ₑ(X¹)_{d-e}(X²)_{3-d} or R¹;
each L is independently absent, an optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, or an optionally substituted aralkylene group having from 7 to 16 carbon atoms and optionally at least one heteroatom;
each X¹ is independently —OR¹ or —OC(═O)R¹;
each X² is R¹;
each R¹ is independently selected from the group consisting of an optionally substituted alkyl group having from 1 to 20 carbon atoms and optionally at least one heteroatom, an optionally substituted alkenyl group having from 2 to 20 carbon atoms and optionally at least one heteroatom, an optionally substituted alkynyl group having from 2 to 20 carbon atoms and optionally at least one heteroatom, an optionally substituted cycloalkyl group having from 3 to 10 carbon atoms and optionally at least one heteroatom, an optionally substituted aryl group having from 6 to 12 carbon atoms and optionally at least one heteroatom, an optionally substituted aralkyl group having from 7 to 16 carbon atoms and optionally at least one heteroatom, and an optionally substituted cyclic silane; or is a divalent group formed from two R¹ groups being bonded together through a covalent bond, with the proviso that if two R¹ groups are bonded together then b is 2 or 3;
G is a polymer fragment having a backbone of carbon atoms covalently bonded together by C—C single bond, C—C double bond or a combination of C—C single bonds and C—C double bonds;
a is 0 or 1; with the proviso that if M is nitrogen, a is 1 or if M is sulfur or oxygen, a is 0;
b is 1, 2, or 3;
c is 1, 2, or 3, with the proviso that c is equal to or less than b;
d is 0, 1, 2, or 3; and
e is 0, 1, 2, or 3, with the proviso that e is equal to or less than d.

8. The polymer of claim 7, wherein Y in formula (II) is selected from the group consisting of 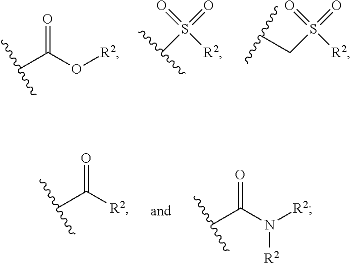
and further wherein:
each R² is independently selected from the group consisting of an optionally substituted alkyl group having from 1 to 20 carbon atoms and optionally at least one heteroatom, an optionally substituted alkenyl group having from 2 to 20 carbon atoms and optionally at least one heteroatom, an optionally substituted cycloalkyl group having from 3 to 14 carbon atoms and optionally at least one heteroatom, an optionally substituted aryl group having from 6 to 16 carbon atoms and optionally at least one heteroatom, and an optionally substituted aralkyl group having from 7 to 20 carbon atoms and optionally at least one heteroatom.

9. The polymer of claim 7, wherein each L is an optionally substituted alkylene group having from 1 to 20 carbon atoms.

10. The polymer of claim 7, wherein each X¹ is —OR¹.

11. The polymer of claim 7, wherein each R¹ is an optionally substituted alkyl group having from 1 to 20 carbon atoms.

12. The polymer of claim 7, wherein
(a) when M is nitrogen, a is 1, and Y is 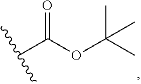 [SMILES: *C(=O)OC(C)(C)C]
the polymer of formula (II) is 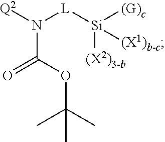
or
(b) when M is nitrogen, a is 1, Q² is -L-Si-(G)ₑ(X)_{d-e}(X²)_{3-d} and Y is 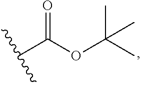 [SMILES: *C(=O)OC(C)(C)C]
the polymer of formula (II) is 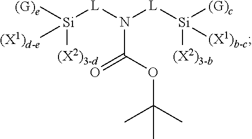
or
(c) when M is nitrogen, a is 1, Q² is R¹, and Y is 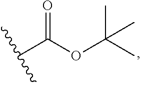 [SMILES: *C(=O)OC(C)(C)C]
the polymer of formula (II) is 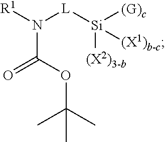
or
(d) when M is nitrogen and a is 1, the polymer of formula (III) is 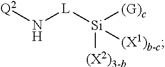
or
(e) when M is nitrogen, a is 1, and Q² is -L-Si-(G)ₑ(X)_{d-e}(X²)_{3-d}, the polymer of formula (III) is

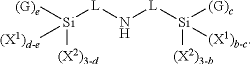

13. The polymer of claim 7, wherein
(a) the polymer of formula (II) is 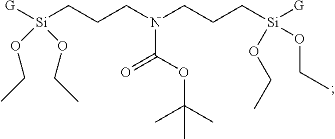
or
(b) the polymer of formula (III) is

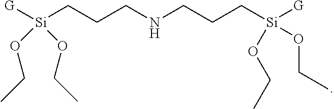

14. The polymer of claim 7, wherein G is a polymer fragment of formula (IV) 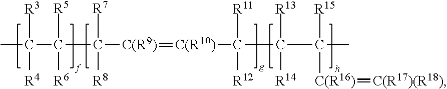
wherein:
each R³, R⁴, R⁵, R⁷, R⁸, R⁹, R¹⁰, R¹¹, R¹², R¹³, R¹⁴, R¹⁵, R¹⁶, R¹⁷ and R¹⁸ is independently an alkyl group having from 1 to 20 carbon atoms, or hydrogen;
each R⁶ is independently selected from the group consisting of hydrogen, an alkyl group having from 1 to 20 carbon atoms and optionally at least one heteroatom, an alkenyl group having from 2 to 20 carbon atoms, a cycloalkyl group having from 3 to 14 carbon atoms, a cycloalkenyl group having from 4 to 14 carbon atoms, an aryl group having from 6 to 16 carbon atoms, and an aralkyl group having from 7 to 20 carbon atoms; and
f, g and h are integers, wherein f is equal to or greater than 0, g is equal to or greater than 0, and h is equal to or greater than 0, with the proviso that the sum of f, g and h is equal to or greater than 1.

15. The polymer of claim 7, wherein the polymer fragment G is styrene butadiene polymer.

16. A method of making the silane compound of formula (I) 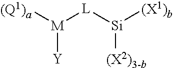
of claim 1, comprising:
reacting a compound of formula (V) 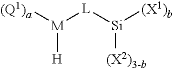
with a protective agent; wherein:
M is selected from the group consisting of nitrogen, sulfur and oxygen;
Y is a protecting group;
Q¹ is -L-Si—(X¹)_{d}(X²)_{3-d} or R¹;
each L is independently absent, an optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, or an optionally substituted aralkylene group having from 7 to 16 carbon atoms and optionally at least one heteroatom;
each X¹ is independently —OR¹ or —OC(═O)R¹;
each X² is R¹;
each R¹ is independently selected from the group consisting of an optionally substituted alkyl group having from 1 to 20 carbon atoms and optionally at least one heteroatom, an optionally substituted alkenyl group having from 2 to 20 carbon atoms and optionally at least one heteroatom, an optionally substituted alkynyl group having from 2 to 20 carbon atoms and optionally at least one heteroatom, an optionally substituted cycloalkyl group having from 3 to 10 carbon atoms and optionally at least one heteroatom, an optionally substituted aryl group having from 6 to 12 carbon atoms and optionally at least one heteroatom, an optionally substituted aralkyl group having from 7 to 16 carbon atoms and optionally at least one heteroatom, and an optionally substituted cyclic silane; or is a divalent group formed from two R¹ groups being bonded together through a covalent bond, with the proviso that if two R¹ groups are bonded together then b is 2 or 3;
a is 0 or 1; with the proviso that if M is nitrogen, a is 1 or if M is sulfur or oxygen, a is 0;
b is 1, 2, or 3; and
d is 0, 1, 2, or 3.

17. The method of claim 16, wherein the protective agent is selected from the group consisting of 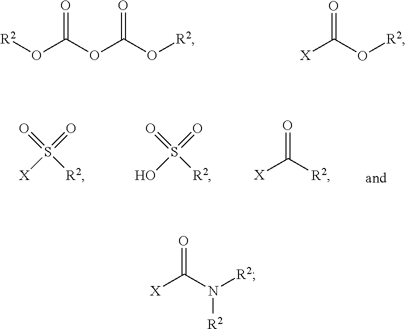
and further wherein:
X is halogen or OR²; and
each R² is independently selected from the group consisting of an optionally substituted alkyl group having from 1 to 20 carbon atoms and optionally at least one heteroatom, an optionally substituted alkenyl group having from 2 to 20 carbon atoms and optionally at least one heteroatom, an optionally substituted cycloalkyl group having from 3 to 14 carbon atoms and optionally at least one heteroatom, an optionally substituted aryl group having from 6 to 16 carbon atoms and optionally at least one heteroatom, and an optionally substituted aralkyl group having from 7 to 20 carbon atoms and optionally at least one heteroatom.

18. The method of claim 16, wherein
(a) when M is nitrogen, a is 1, and Y is 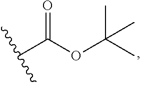 [SMILES: *C(=O)OC(C)(C)C]
the silane compound of formula (I) is 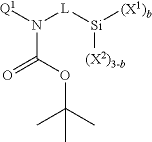
and is prepared by reacting the compound of formula (V) 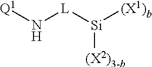
with the protective agent 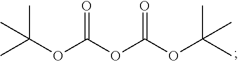
or
(b) when M is nitrogen, a is 1, and Y is 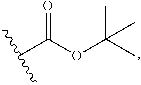 [SMILES: *C(=O)OC(C)(C)C]
and Q¹ is -L-Si—(X¹)_{d}(X²)_{3-d}, the silane compound of formula (I) is 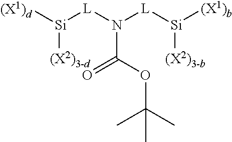
and is prepared by reacting the compound of formula (V) 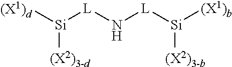
with the protective agent 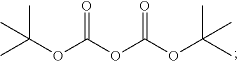
or
(c) when M is nitrogen, a is 1, d is 3, Y is 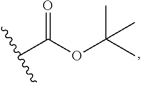 [SMILES: *C(=O)OC(C)(C)C]
Q¹ is -L-Si—(X¹)_{d}(X²)_{3-d}, L is —CH₂CH₂CH₂—, X¹ is —OR¹, and R¹ is —CH₂CH₃, the silane compound of formula (I) is 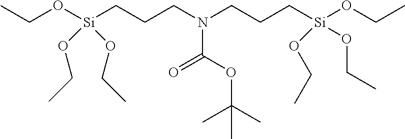 [SMILES: CCO[Si](CCCN(CCC[Si](OCC)(OCC)OCC)C(=O)OC(C)(C)C)(OCC)OCC]
and is prepared by reacting the compound of formula (V) 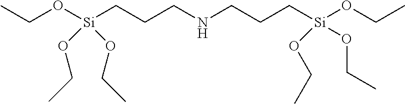 [SMILES: CCO[Si](CCCNCCC[Si](OCC)(OCC)OCC)(OCC)OCC]
with the protective agent 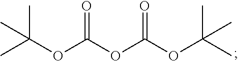
or
(d) when M is nitrogen, a is 1, Y is 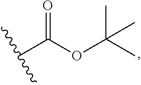 [SMILES: *C(=O)OC(C)(C)C]
and Q¹ is R¹, the silane compound of formula (I) is 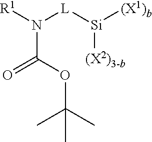
and is prepared by reacting the compound of formula (V) 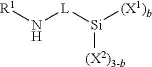
with the protective agent 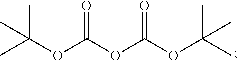
or
(e) when M is sulfur, a is 0, and Y is 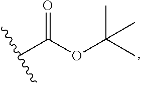 [SMILES: *C(=O)OC(C)(C)C]
the silane compound of formula (I) is 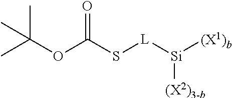
and is prepared by reacting the compound of formula (V) 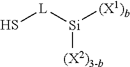
with the protective agent

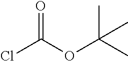

19. A method of making the polymer of claim 7, wherein the polymer is represented by formula (II) 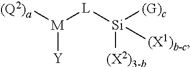
and is prepared by
(i) reacting a chain of C—C unsaturated carbon atom monomers with an anionic initiator to form a polymer fragment G; and
(ii) reacting the polymer fragment G with a silane compound of formula (I) 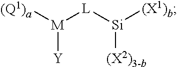
wherein:
M is selected from the group consisting of nitrogen, sulfur and oxygen;
Y is a protecting group;
Q¹ is -L-Si—(X)_{d}(X²)_{3-d} or R¹;
Q² is -L-Si-(G)ₑ(X¹)_{d-e}(X²)_{3-d} or R¹; with the proviso that if Q¹ is -L-Si—(X)_{d}(X²)_{3-d}, Q² is -L-Si-(G)ₑ(X¹)_{d-e}(X²)_{3-d}; and if Q¹ is R¹, Q² is R¹;
each L is independently absent, an optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, or an optionally substituted aralkylene group having from 7 to 16 carbon atoms and optionally at least one heteroatom;
each X¹ is independently —OR¹ or —OC(═O)R¹;
each X² is R¹;
each R¹ is independently selected from the group consisting of an optionally substituted alkyl group having from 1 to 20 carbon atoms and optionally at least one heteroatom, an optionally substituted alkenyl group having from 2 to 20 carbon atoms and optionally at least one heteroatom, an optionally substituted alkynyl group having from 2 to 20 carbon atoms and optionally at least one heteroatom, an optionally substituted cycloalkyl group having from 3 to 10 carbon atoms and optionally at least one heteroatom, an optionally substituted aryl group having from 6 to 12 carbon atoms and optionally at least one heteroatom, and an optionally substituted aralkyl group having from 7 to 16 carbon atoms and optionally at least one heteroatom;
a is 0 or 1; with the proviso that if M is nitrogen, a is 1 or if M is sulfur or oxygen, a is 0;
b is 1, 2, or 3;
c is 1, 2, or 3, with the proviso that c is equal to or less than b;
d is 0, 1, 2, or 3; and
e is 0, 1, 2, or 3, with the proviso that e is equal to or less than d.

20. The method of claim 19, wherein
(a) when M is nitrogen, a is 1, and Y is 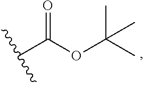 [SMILES: *C(=O)OC(C)(C)C]
the polymer of formula (II) is 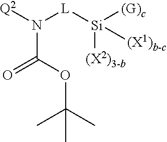
and is prepared by reacting the polymer fragment G with the silane compound of formula (I) 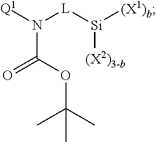
or
(b) when M is nitrogen, a is 1, Y is 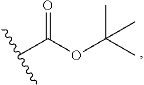 [SMILES: *C(=O)OC(C)(C)C]
and Q² is -L-Si-(G)ₑ(X¹)_{d-e}(X²)_{3-d}, the polymer of formula (II) is 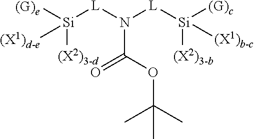
and is prepared by reacting the polymer fragment G with the silane compound of formula (I) 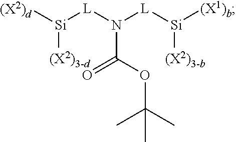
or
(c) when M is nitrogen, a is 1 Y is 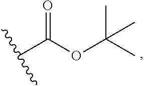 [SMILES: *C(=O)OC(C)(C)C]
Q² is -L-Si-(G)ₑ(X¹)_{d-e}(X²)_{3-d}, d is 3, L is —CH₂CH₂CH₂—, e is 1, X¹ is —OR¹, and R¹ is —CH₂CH₃, the polymer of formula (II) is 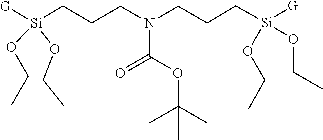
and is prepared by reacting the polymer fragment G with the silane compound of formula (I) 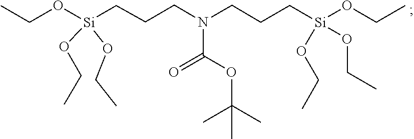 [SMILES: CCO[Si](CCCN(CCC[Si](OCC)(OCC)OCC)C(=O)OC(C)(C)C)(OCC)OCC]
(d) when M is nitrogen, a is 1, Y is 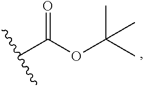 [SMILES: *C(=O)OC(C)(C)C]
and Q² is R¹, the polymer of formula (II) is 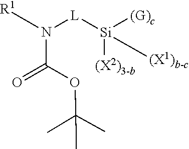
and is prepared by reacting the polymer fragment G with the silane compound of formula (I) 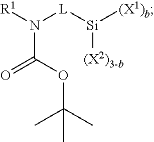
or
(e) when M is sulfur, Y is 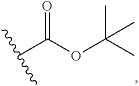 [SMILES: *C(=O)OC(C)(C)C]
and a is 0, the polymer of formula (II) is 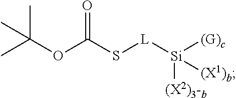
and is prepared by reacting the polymer fragment G with the silane compound of formula (I)

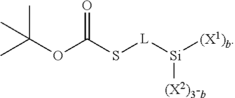

21. The method of claim 19, wherein the anionic initiator is n-butyllithium.

22. A method of making the polymer of claim 7, wherein the polymer is represented by formula (III) 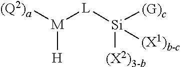
comprising reacting a polymer of formula (II) 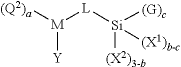
with an acid, a base, or heat, wherein:
M is selected from the group consisting of nitrogen, sulfur and oxygen;
Y is a protecting group;
Q² is -L-Si-(G)ₑ(X¹)_{d-e}(X²)_{3-d} or R¹;
each L is independently absent, an optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, or an optionally substituted aralkylene group having from 7 to 16 carbon atoms and optionally at least one heteroatom;
each X¹ is independently —OR¹ or —OC(═O)R¹;
each X² is R¹;
each R¹ is independently selected from the group consisting of an optionally substituted alkyl group having from 1 to 20 carbon atoms and optionally at least one heteroatom, an optionally substituted alkenyl group having from 2 to 20 carbon atoms and optionally at least one heteroatom, an optionally substituted alkynyl group having from 2 to 20 carbon atoms and optionally at least one heteroatom, an optionally substituted cycloalkyl group having from 3 to 10 carbon atoms and optionally at least one heteroatom, an optionally substituted aryl group having from 6 to 12 carbon atoms and optionally at least one heteroatom, and an optionally substituted aralkyl group having from 7 to 16 carbon atoms and optionally at least one heteroatom;
G is a polymer fragment having a backbone of carbon atoms covalently bonded together by C—C single bond, C—C double bond or a combination of C—C single bonds and C—C double bonds;
a is 0 or 1; with the proviso that if M is nitrogen, a is 1 or if M is sulfur or oxygen, a is 0;
b is 1, 2, or 3;
c is 1, 2, or 3, with the proviso that c is equal to or less than b;
d is 0, 1, 2, or 3; and
e is 0, 1, 2, or 3, with the proviso that e is equal to or less than d.

23. The method of claim 22, wherein
(a) when M is nitrogen and a is 1, the polymer of formula (III) is 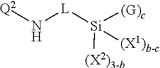
and is prepared by reacting the polymer of formula (II) 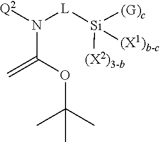
in the presence of an acid, a base, or heat; or
(b) when M is nitrogen, a is 1, and Q² is -L-Si-(G)ₑ(X¹)_{d-e}(X²)_{3-d}, the polymer of formula (III) is 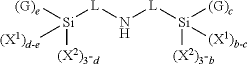
and is prepared by reacting the polymer of formula (II) 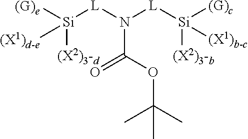
in the presence of an acid, a base, or heat; or
(c) when M is nitrogen a is 1, Y is 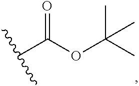 [SMILES: *C(=O)OC(C)(C)C]
Q² is -L-Si-(G)ₑ(X¹)_{d-e}(X²)_{3-d}, d is 3, L is —CH₂CH₂CH₂—, e is 1, b is 3, X¹ is —OR¹, and R¹ is —CH₂CH₃, the polymer of formula (III) is 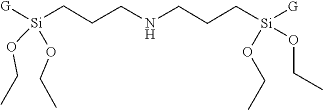
and is prepared by reacting the polymer of formula (II) 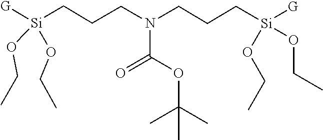
in the presence of an acid, a base, or heat; or
(d) when M is nitrogen, a is 1, and Q² is R¹, the polymer of formula (III) is 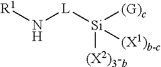
and is prepared by reacting the polymer of formula (II) 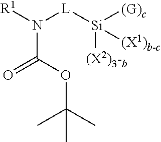
in the presence of an acid, a base, or heat.

24. A rubber composition comprising one or more polymers of claim 7.

25. Use of the polymer of claim 7 in a rubber composition.
